(19) United States
(12) Patent Application Publication
(10) Pub. No.: US 2025/0350501 A1
(43) Pub. Date: Nov. 13, 2025

(54) RECURRENT EQUIVARIANT INFERENCE MACHINES FOR REFINING 5G AMMSE CROSS-SLOT CHANNEL ESTIMATION

(71) Applicant: QUALCOMM Incorporated, San Diego, CA (US)

(72) Inventors: Kumar PRATIK, Amsterdam (NL); Arash BEHBOODI, Amsterdam (NL); Pouriya SADEGHI, San Diego, CA (US); Yuanning YU, Santa Clara, CA (US); Supratik BHATTACHARJEE, San Diego, CA (US); Joseph Binamira SORIAGA, San Diego, CA (US); Reneeta Sara ISAAC, Bangalore (IN)

(21) Appl. No.: 18/662,633

(22) Filed: May 13, 2024

(51) Int. Cl. H04L 25/02; H04L 27/26

(52) U.S. Cl. CPC H04L 25/0204; H04L 27/26025; H04L 27/2613

(57) ABSTRACT

The apparatus may be a wireless device configured to estimate, for a first transmission in a first slot, a first channel associated with the first transmission, wherein the first transmission is associated with a first precoding, receive, in a second slot following the first slot, a second transmission associated with a second precoding, and estimate, based on the received second transmission and at least one of the received first transmission or the estimated first channel, a second channel associated with the second transmission.

### TECHNICAL FIELD

The present disclosure relates generally to communication systems, and more particularly, to channel estimation and decoding associated with wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device configured to estimate, for a first transmission in a first slot, a first channel associated with the first transmission, wherein the first transmission is associated with a first precoding, receive, in a second slot following the first slot, a second transmission associated with a second precoding, and estimate, based on the received second transmission and at least one of the received first transmission or the estimated first channel, a second channel associated with the second transmission.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating aspects of multiple input multiple output (MIMO) communication in accordance with some aspects of the disclosure.

FIG. 5 is a diagram illustrating a different pre-coding applied to a same physical resource block group (PRG) in adjacent slots in accordance with some aspects of the disclosure.

FIG. 6 is an example of the artificial intelligence (AI)/machine learning (ML) algorithm for cross-slot channel estimation in wireless communication and illustrates various aspects model training, model inference, model feedback, and model update.

FIG. 7 is a diagram illustrating a first operation of a ML based cross-slot channel estimation in accordance with some aspects of the disclosure.

FIG. 8 is a diagram illustrating an example refinement network including a plurality of refinement units in accordance with some aspects of the disclosure.

FIG. 9 is a diagram illustrating the generation of the gradient at a likelihood module of a single refinement unit in accordance with some aspects of the disclosure.

FIG. 10 is a diagram illustrating components of an encoder in accordance with some aspects of the disclosure.

FIG. 11 is a diagram illustrating a fusion convolutional neural network (CNN) of an encoder in accordance with some aspects of the disclosure.

FIG. 12 is a diagram illustrating an intra-PRG attention module of an encoder in accordance with some aspects of the disclosure.

FIG. 13 is a diagram illustrating an inter-PRG attention module of an encoder in accordance with some aspects of the disclosure.

FIG. 14 is a diagram illustrating a cross-MIMO attention module of an encoder in accordance with some aspects of the disclosure.

FIG. 15 is a diagram illustrating a cross-slot attention module of an encoder in accordance with some aspects of the disclosure.

FIG. 16 is a diagram illustrating a decoder in accordance with some aspects of the disclosure.

FIG. 17 is a diagram illustrates a MT network associated with a recurrent equivariant inference machine for refining adaptive minimum mean square error (AMMSE) cross-slot channel estimation in accordance with some aspects of the disclosure.

FIG. 18 is a call flow diagram illustrating a method of wireless communication in accordance with some aspects of the disclosure.

FIG. 19 is a flowchart of a method of wireless communication.

FIG. 20 is a flowchart illustrating additional sub-operations of estimating, based on the received second transmission and at least one of the received first transmission or the estimated first channel, a second channel associated with the second transmission associated with the method of wireless communication illustrated in FIG. 19.

FIG. 21 is a flowchart of a method of wireless communication.

FIG. 22 is a diagram illustrating an example of a hardware implementation for an example apparatus and/or network entity.

### DETAILED DESCRIPTION

In some aspects of wireless communication, e.g., a fast fading environment, obtaining accurate channel state information (CSI) may be important to maintain high data throughput. Orthogonal frequency division multiplexing (OFDM) systems often deploy pilot-based channel estimation techniques for obtaining CSI with sufficient accuracy. In some aspects of wireless communication, e.g., 5G NR, these pilot symbols may be referred to as demodulation reference signals (DMRS). In every transmission slot, DMRS symbols may be inserted for effective channel estimation used for demodulation at non-DMRS locations in that slot. In some aspects of 5G NR a fixed set of possible DMRS patterns may be configured and/or allowed. Depending on the channel characteristics, the optimal DMRS pattern, i.e., the DMRS pattern with the best expected data throughput, may be used. Channel estimation, in some aspects, involves finding the unknown values of the channel response (e.g., at non-DMRS locations) using some known channel responses at pilot locations (e.g., DMRS locations).

Various aspects relate generally to taking advantage of the correlation across slots in the DMRS-based channel estimation problem. Some aspects more specifically relate to taking advantage of the correlation across slots in the DMRS-based channel estimation problem with low additional complexity by adding an estimated channel from a last slot as input, and adding a cross-slot attention component in the refinement network encoder. In some examples, a wireless device may be configured to estimate, for a first transmission in a first slot, a first channel associated with the first transmission, wherein the first transmission is associated with a first precoding, receive, in a second slot following the first slot, a second transmission associated with a second precoding, and estimate, based on the received second transmission and at least one of the received first transmission or the estimated first channel, a second channel associated with the second transmission.

Particular aspects of the subject matter described in this disclosure can be implemented to realize one or more of the following potential advantages. In some examples, by adding an estimated channel from a last slot as input, and adding a cross-slot attention component in the refinement network encoder, the described techniques can be used to improve channel estimation accuracy over AMMSE or MMSE with varying per-slot precoder, DMRS patterns, number of resource blocks associated with a channel estimation unit, and/or number of layers.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

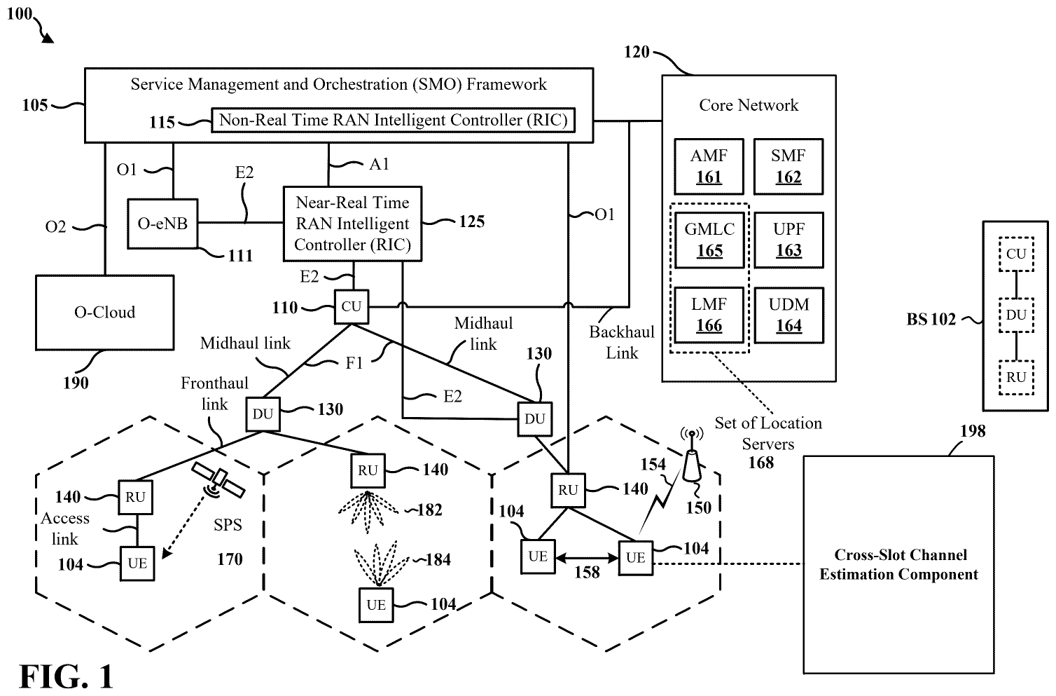

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a cross-slot channel estimation component 198 that may be configured to estimate, for a first transmission in a first slot, a first channel associated with the first transmission, wherein the first transmission is associated with a first precoding, receive, in a second slot following the first slot, a second transmission associated with a second precoding, and estimate, based on the received second transmission and at least one of the received first transmission or the estimated first channel, a second channel associated with the second transmission. Although the following description may be focused on 5G NR, the concepts described herein may be applicable to other similar areas, such as LTE, LTE-A, CDMA, GSM, and other wireless technologies.

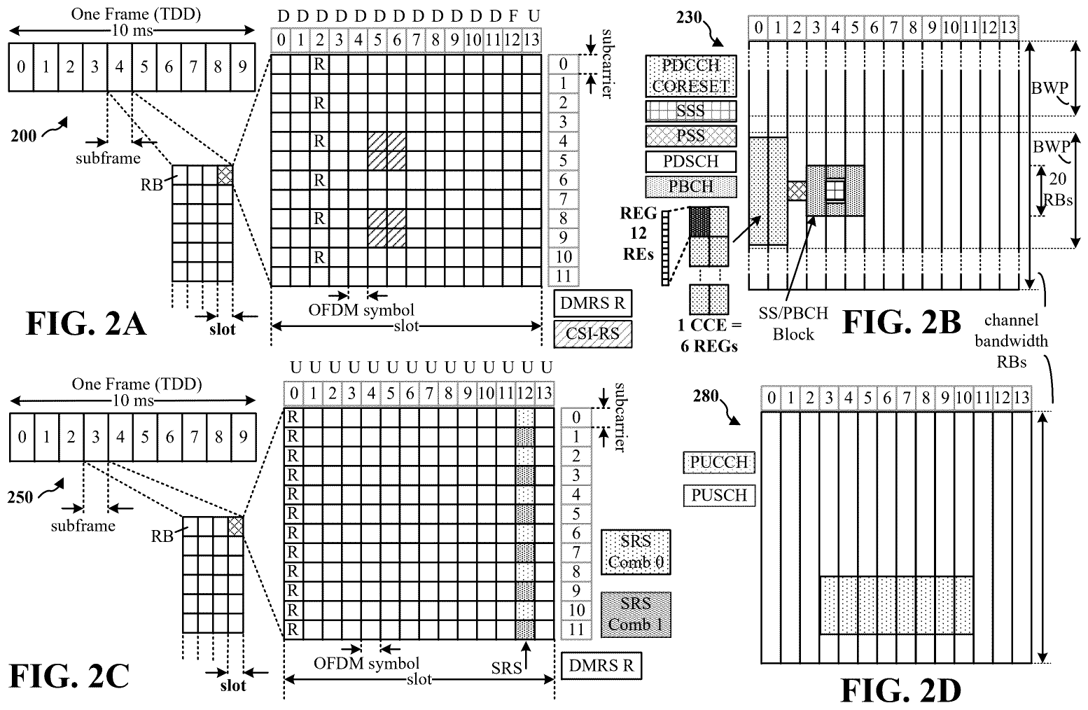

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2″ slots/subframe. The subcarrier spacing may be equal to 2″*15 kHz, where μ is the numerology 0 to 4. As such, the numerology μ=0 has a subcarrier spacing of 15 kHz and the numerology u=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

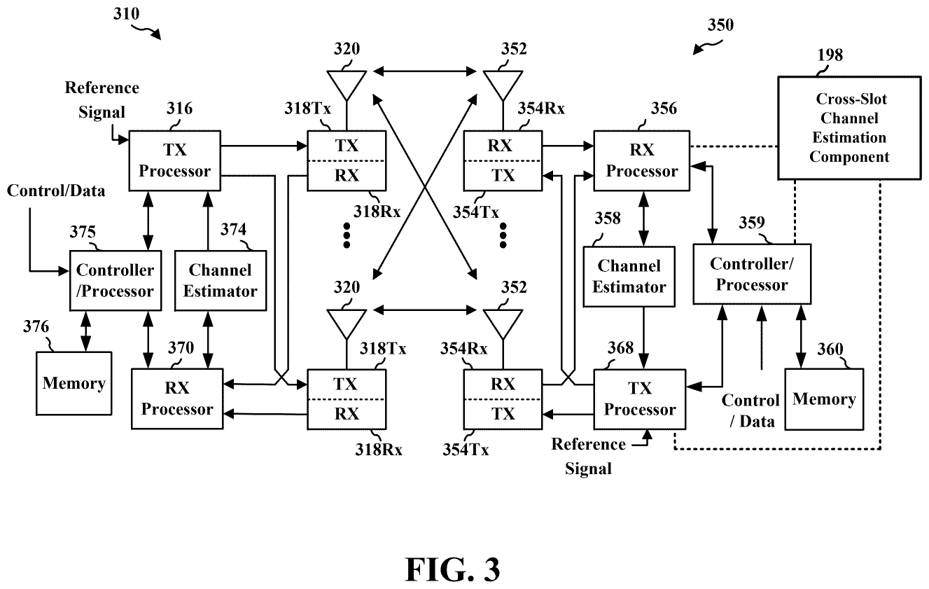

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the cross-slot channel estimation component 198 of FIG. 1.

In some aspects of wireless communication, e.g., a fast fading environment, obtaining accurate CSI may be important to maintain high data throughput. OFDM systems often deploy pilot-based channel estimation techniques for obtaining CSI with sufficient accuracy. In some aspects of wireless communication, e.g., 5G NR, these pilot symbols may be referred to as DMRS. In every transmission slot, DMRS symbols may be inserted for effective channel estimation used for demodulation at non-DMRS locations in that slot. In some aspects of 5G NR a fixed set of possible DMRS patterns may be configured and/or allowed. Depending on the channel characteristics, the optimal DMRS pattern, i.e., the DMRS pattern with the best expected data throughput, may be used. Channel estimation, in some aspects, involves finding the unknown values of the channel response (e.g., at non-DMRS locations) using some known channel responses at pilot locations (e.g., DMRS locations).

Various aspects relate generally to taking advantage of the correlation across slots in the DMRS-based channel estimation problem. Some aspects more specifically relate to taking advantage of the correlation across slots in the DMRS-based channel estimation problem with low additional complexity by adding an estimated channel from a last slot as input, and adding a cross-slot attention component in the refinement network encoder. In some examples, a wireless device may be configured to estimate, for a first transmission in a first slot, a first channel associated with the first transmission, wherein the first transmission is associated with a first precoding, receive, in a second slot following the first slot, a second transmission associated with a second precoding, and estimate, based on the received second transmission and at least one of the received first transmission or the estimated first channel, a second channel associated with the second transmission.

Particular aspects of the subject matter described in this disclosure can be implemented to realize one or more of the following potential advantages. In some examples, by adding an estimated channel from a last slot as input, and adding a cross-slot attention component in the refinement network encoder, the described techniques can be used to improve channel estimation accuracy over adaptive minimum mean square error (AMMSE) or MMSE with varying per-slot precoder, DMRS patterns, number of resource blocks associated with a channel estimation unit, and/or number of layers.

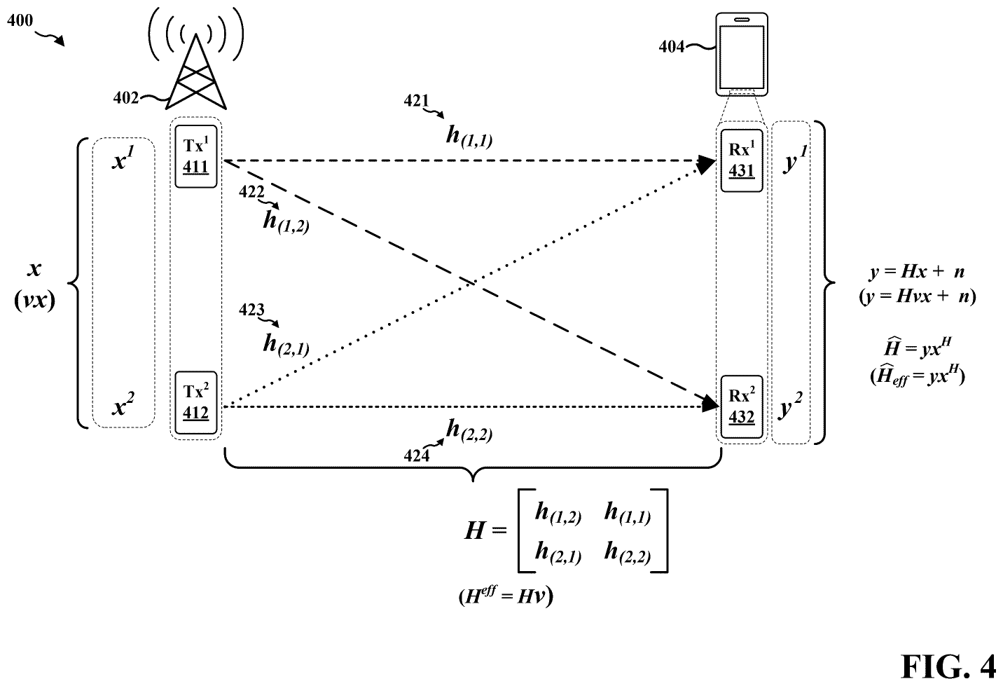

FIG. 4 is a diagram 400 illustrating aspects of MIMO communication in accordance with some aspects of the disclosure. Diagram 400 includes a multi-antenna base station 402 (e.g., as an example of a source device) in communication with a multi-antenna UE 404 (e.g., as an example of a target and/or destination device). The multi-antenna base station 402, in some aspects, may include a first antenna 411 (Tx¹) and may include a second antenna 412 (Tx²) and the multi-antenna UE 404 may include a first antenna 431 (Rx¹) and may include a second antenna 432 (Rx²). The multi-antenna base station 402, in some aspects, transmits a signal x including a DMRS (e.g., x_{dmrs}) that may include a first DMRS component (e.g.,

$${x}_{dmrs}^{1} )$$

transmitted from the first antenna 411 and a second DMRS component (e.g.,

$${x}_{dmrs}^{2} )$$

transmitted from the second antenna 412. In some aspects, the transmitted signal may be pre-coded using a pre-coding matrix, v, such that the transmitted signal is vx and the first DMRS component (e.g.,

$$v {x}_{dmrs}^{1} )$$

is transmitted from the first antenna 411 and the second DMRS component (e.g.,

$$v {x}_{dmrs}^{2} )$$

is transmitted from the second antenna 412 after (or based on) the pre-coding. The pre-coding matrix, in some aspects, may be associated with a beam forming from the transmit antennas to the receive antennas.

The transmitted DMRS (and associated data) may experience a channel (e.g., represented as a matrix H (based on component channels h_{1,1} 421, h_{1,2} 422, h_{2,1} 423, and h_{2,2} 424) representing an effect, such as attenuation and/or phase shift, associated with propagation from the multi-antenna base station 402 to the multi-antenna UE 404). Based on the channel, the multi-antenna UE 404 may receive a signal y=Hx+n (or y=Hvx+n) including a first component (e.g., y¹) received at the first antenna 431 and second component (e.g., y²) received at the second antenna 432. In some aspects of (narrowband) MIMO communication, precoding may be defined for a PRB group (PRG) including a plurality of PRBs (e.g., two or four PRBs). A pre-coding may be different across different PRGs and may not be known to the multi-antenna UE 404.

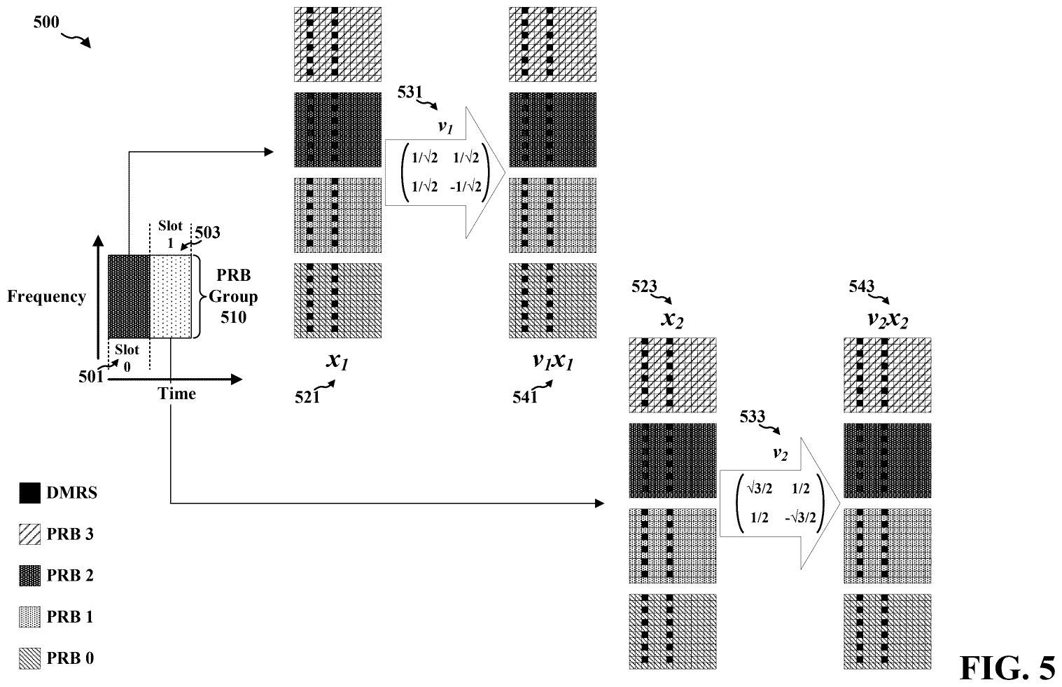

FIG. 5 is a diagram 500 illustrating a different pre-coding applied to a same PRG in adjacent slots in accordance with some aspects of the disclosure. A pre-coder change, in some aspects, may occur between different (adjacent) time-slots without the UE being notified. For example, for a first slot 501 and PRG 510, a first pre-coding 531 (v₁) may be applied to a first signal/data 521 (x₁) to produce a first transmitted signal/data 541 (v₁x₁), while for a second slot 503 and PRG 510, a second pre-coding 533 (v₂) may be applied to a second signal/data 523 (x₂) to produce a second transmitted signal/data 543 (v₂x₂). The first and second pre-coding may be unknown to a UE before a channel estimation and/or decoding operation (e.g., a blind decoding considering multiple possible pre-codings). Minimum mean square error (MMSE) or adaptive MMSE (AMMSE) based channel estimation algorithms, in some aspects, may not use correlation between differently pre-coded time-slots such as those illustrated in FIG. 5.

For example, MMSE or AMMSE based channel estimation algorithms may perform a processing that is per-slot, per-PRG, and per antenna port pair (e.g., Tx-Rx antenna pairs). MMSE and/or MMSE variants, based channel estimation algorithms, in some aspects, may further be associated with a linear interpolation (e.g., excluding non-linear interpolation) and may be associated with using a sub-optimal cover code de-spreading method to mitigate MIMO multiplexing and/or interference effects. In some aspects, AMMSE based channel estimation algorithms may improve the (classical) MMSE based channel estimation algorithms (e.g., may produce a low estimation error under appropriate conditions) but may be based on knowledge of second-order channel statistics and noise variance, be associated with high computational expense. For practicality, the AMMSE channel estimation algorithms, in some aspects, may use binning-based strategies, e.g., based on estimated channel parameters, like Doppler shift, delay spread, etc., where linear MMSE (LMMSE) parameters of a resulting bin may be selected for channel estimation.

Cross-slot AMMSE channel estimation algorithms, in some aspects, may include one or more channel estimation algorithms based on the DMRS associated with a previous slot using a same pre-coding as the pre-coding used for the current slot. Accordingly, the AMMSE channel estimation algorithms, in some aspects, may include a pre-coder change detection module and/or operation to determine if a pre-coder has changed from a previous slot where the one or more channel estimation algorithms based on the DMRS associated with a previous slot are applied when a pre-coder is determined not to have changed between slots. In some aspects, the pre-coder change detection module and/or operation may be based on a sub-optimal heuristic. If the pre-coder is detected to have changed, the cross-slot AMMSE reverts to the per-slot AMMSE and suffers from the same deficiencies as the AMMSE channel estimation algorithms described above (e.g., does not model correlations across different PRGs, MIMO layers, and different slots).

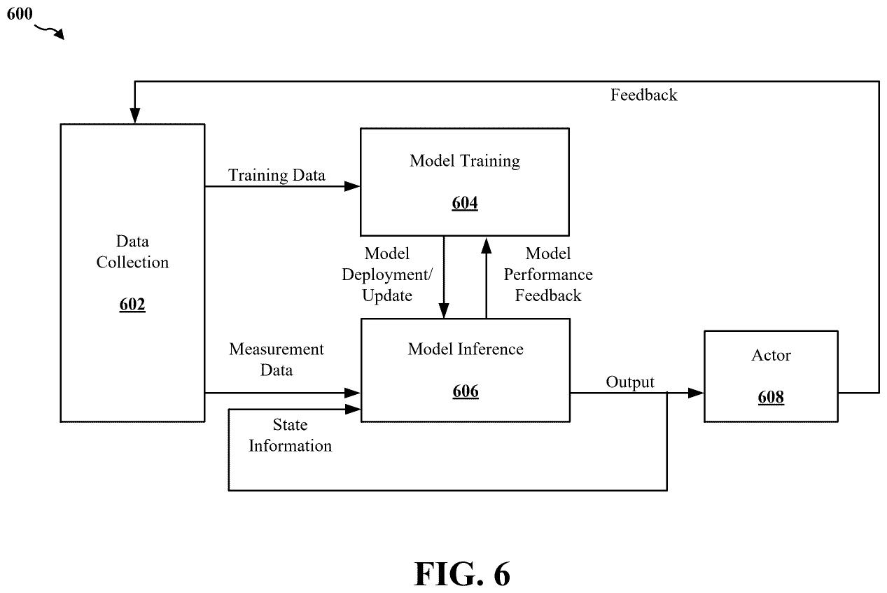

FIG. 6 is an example of the AI/ML algorithm 600 for cross-slot channel estimation in wireless communication and illustrates various aspects model training, model inference, model feedback, and model update. The AI/ML algorithm 600 may include various aspects including a data collection 602, a model training 604, model inference 606, and an actor 608 that receives and uses output based on the model inference.

The data collection 602 may be a function that provides input data for the model training 604 and the model inference 606. The data collection 602 function may include any form of data preparation, and it may not be specific to the implementation of the AI/ML algorithm (e.g., data pre-processing and cleaning, formatting, and transformation).

The examples of input data may include, but are not limited to, measurements, such as channel measurements, such as CSI from entities including UEs or network nodes, feedback from the actor 608 (e.g., which may be a UE or network node), output from another AI/ML model. The data collection 602 may include training data, which refers to the data to be sent as the input for the AI/ML model training 604, and inference data, which refers to data input for the AI/ML model inference (e.g., model inference 606).

The model training 604 may be a function that performs the ML model training, validation, and testing, which may generate model performance metrics as part of the model testing procedure. The model training 604 may also include data preparation (e.g., data pre-processing and cleaning, formatting, and transformation) based on the training data delivered or received from the data collection 602 function. The model training 604 component may deploy or update a trained, validated, and tested AI/ML model to the model inference 606 component, and receive a model performance feedback from the model inference 606 component. As described above, there may be various functionalities to be performed by an AI/ML model for wireless communication

The model inference 606 may be a function that provides the AI/ML model inference output (e.g., predictions or decisions). The model inference 606 may also perform data preparation (e.g., data pre-processing and cleaning, formatting, and transformation) based on the inference data delivered from the data collection 602 function. In some aspects, the model inference 606 may further provide the AI/ML model inference output based on an output (e.g., latent/state information) of a previous inference. The output of the model inference 606 may include the inference output of the AI/ML model produced by the model inference 606. The details of the inference output may be use case specific. As an example, the output may include channel estimation and latent (or state) information for one or more PRBs, PRGs, and/or layers associated with the measurement data and/or inference. While discussed below in relation to output for a receiver, the prediction may be for the transmitter or the receiver and may be for the network or the UE. In some aspects, the actor may be a component of the base station or of a core network. In other aspects, the actor may be a UE in communication with a wireless network.

The model performance feedback may refer to information derived from the model inference 606 function that may be suitable for the improvement of the AI/ML model trained in the model training 604. The feedback from the actor 608 or other network entities (via the data collection 602 function) may be implemented for the model inference 606 to create the model performance feedback.

The actor 608 may be a function that receives the output from the model inference 606 and triggers or performs corresponding actions. The actor may trigger actions directed to network entities including the other network entities or itself. The actor 608 may also provide a feedback information that the model training 604 or the model inference 606 to derive training or inference data or performance feedback. The feedback may be transmitted back to the data collection 602.

A network or UE may use machine-learning algorithms, deep-learning algorithms, neural networks, reinforcement learning, regression, boosting, or advanced signal processing methods for aspects of wireless communication including the various functionalities such as channel state estimation associated with decoding a received transmission, among other examples.

In some aspects described herein, the network may train one or more neural networks to learn the dependence of measured qualities on individual parameters. Among others, examples of machine learning models or neural networks that may be included in the network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks; genetic algorithms; deep convolutional networks (DCNs) configured with additional pooling and normalization layers; and deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by the concatenation of one or more of the referenced operations. Examples of operations that may be involved include extraction of various features of data, convolution operations, fully connected operations that may be activated or deactivated, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution AxB operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., any feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from input at a first layer through the multiple layers of the neural network to output at the last layer of the neural network and may traverse layers multiple times.

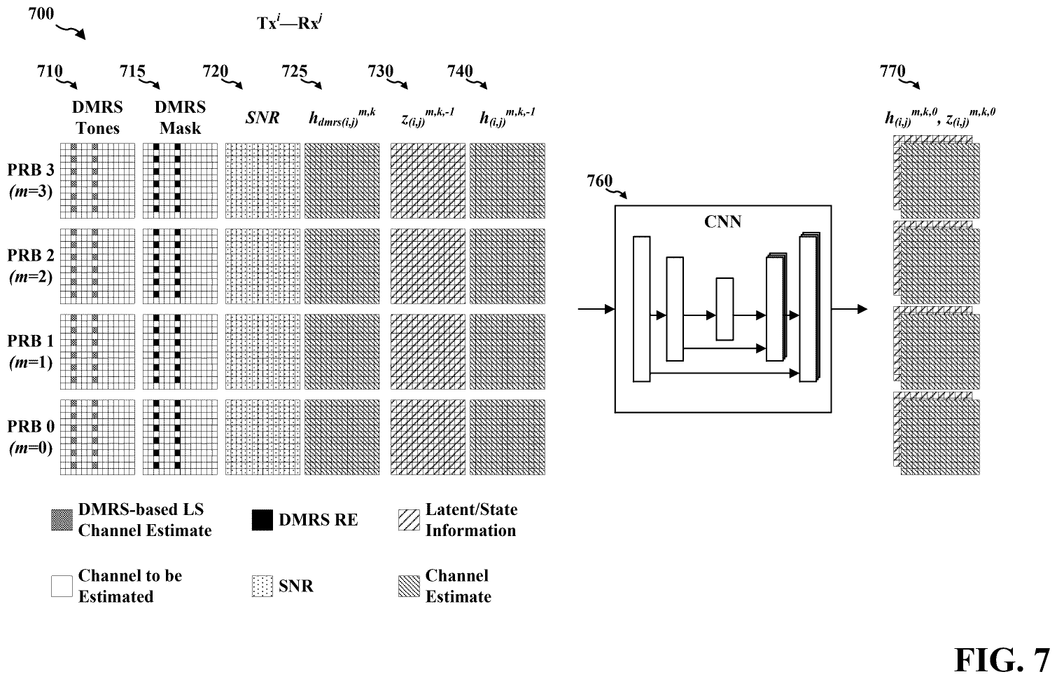

FIG. 7 is a diagram 700 illustrating a first operation of a ML based cross-slot channel estimation in accordance with some aspects of the disclosure. Diagram 700 illustrates inputs and outputs of a first CNN 760 (as an example of a machine-trained (MT) network or neural network). A received transmission, in some aspects, may be a MIMO transmission, e.g., a transmission associated with a set of layers and/or antenna port pairs based on a set of transmit antennas (e.g., Txⁱ for i∈{1, . . . , I}) and a set of receive antennas (e.g., Rx^{j} for j∈{1, . . . , J}). Each layer in the set of layers may be associated with a set of K PRGs (e.g., a set of PRGₖ for k∈{1, . . . , K}) and each PRG may be associated with a plurality of M PRBs (e.g., a set of PRBₘ for m∈{1, . . . , M}). In some aspects, M may be equal to two or four. Each PRG may be associated with a pre-coding (e.g., a different or same pre-coding), a DMRS pattern, and a SCS selected to optimize a set of characteristics of the transmission. In some aspects, the DMRS pattern and SCS may be the same for PRGs within a same slot.

The CNN 760, in some aspects, may be configured to accept input, and produce output, for a particular antenna port pair (e.g., a Txⁱ-Rx^{j} pair which may be referred to as a single input single output (SISO) channel) and a particular PRG (e.g., a PRGₖ) and may be applied independently for each antenna port pair for each PRG. For each antenna port pair for each PRG, the input to the CNN 760 may include a set of DMRS tones 710 (e.g., a determined/estimated channel based on a received and/or observed DMRS signal and/or symbol) at a set of DMRS locations in a time and frequency grid associated with a set of PRBs making up the PRG (e.g., least squares channel estimates at DMRS REs). The CNN 760 may further be provided with a set of DMRS masks 715 indicating the location of the DMRS transmissions, signal to noise ratio (SNR) information 720, an AMMSE or MMSE (SISO) channel estimate

$$725 ( {h}_{dmrs , ( i , j )}^{k} or {\{ {h}_{dmrs , ( i , j )}^{m , k} \}}_{∀ m} ) ,$$

a set of (SISO) latent/state information

$$730 ( {z}_{( i , j )}^{k , - 1} or {\{ {z}_{( i , j )}^{m , k , - 1} \}}_{∀ m} )$$

associated with a previous slot (or initialized to 0 for a first slot), and a set of (SISO) channel estimates

$$740 ( {h}_{( i , j )}^{k , - 1} or {\{ {h}_{( i , j )}^{m , k , - 1} \}}_{∀ m} )$$

associated with a previous slot (or initialized to 0 for a first slot).

The CNN 760, for the particular antenna port pair (e.g., a Txⁱ-Rx^{j} pair) and the particular PRG (e.g., a PRGₖ), may produce output 770 including a set of channel estimates (e.g., a set of single input single output (SISO) channel estimations)

$${h}_{( i , j )}^{k , 0} or {\{ {h}_{( i , j )}^{m , k , 0} \}}_{∀ m}$$

and a set of latent/state information

$${z}_{( i , j )}^{k , 0} or {\{ {z}_{( i , j )}^{m , k , 0} \}}_{∀ m} .$$

The output of the CNN 760 applied for the set of antenna port pairs (e.g., the {Txⁱ-Rx^{j}}_{∀i,j} pairs) and the set of PRGs (e.g., {PRGₖ}_{∀k}) may include a combined channel estimate H⁰ (including the SISO channel estimations

$${\{ {h}_{( i , j )}^{m , k , 0} \}}_{∀ i , j , m , k} )$$

anu a set of latent/state information z⁰ (including the SISO latent/state information

$${\{ {z}_{( i , j )}^{m , k , 0} \}}_{∀ i , j , m , k} )$$

and may be provided to a refinement network. For example, the output of the CNN 760 for the particular antenna port pair (e.g., a Txⁱ-Rx^{j} pair) and the particular PRG (e.g., a PRGₖ) may be related to a posterior probability of channel characteristics H (or

$${\{ {h}_{( i , j )}^{m , k} \}}_{∀ m}$$

given the known values for a transmitted DMRS signal

$${x}_{dmrs , ( i , j )}^{m , k}$$

and a received DMRS signal

$${y}_{dmrs , ( i , j )}^{m ,} or ( {arg {max}_{s , m , k}}_{{h}_{i , j}} P [ {h}_{( i , j )}^{s , m , k} \vert \{ {x}_{dmrs , ( i , j )}^{s , m , k} , {y}_{dmrs , ( i , j )}^{s , m , k} : ∀ i , j , m , k \} ]$$

for a slot s). For example, the equations described above may relate to maximizing the joint channel estimate across all the PRGs given the set of x and y (e.g., the transmitted and received and/or observed DMRS) for each PRG. In some aspects, the equations reflect, for the most part, the inter-PRG effect but, by calculating the equations over the range of i and j, the joint MIMO channel estimate may be considered instead of only performing a SISO processing associated with a SISO channel estimate.

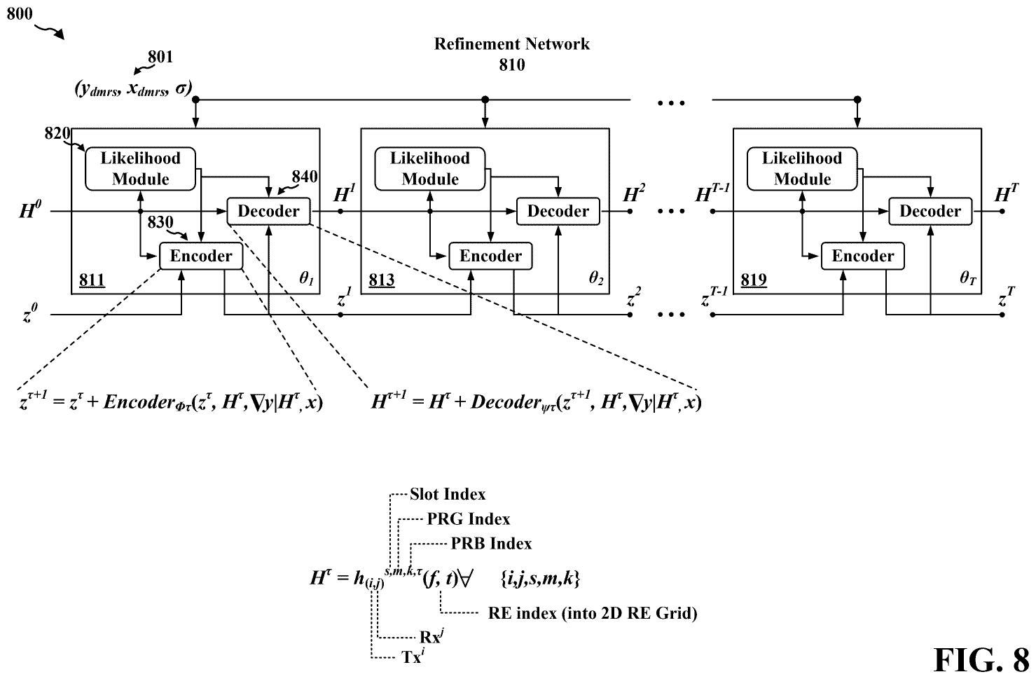

FIG. 8 is a diagram 800 illustrating an example refinement network 810 including a plurality of refinement units in accordance with some aspects of the disclosure. The refinement network 810, in some aspects, may receive the set of SISO channel estimates (H⁰ or

$${\{ {h}_{( i , j )}^{m , k , 0} \}}_{∀ i , j , m , k} ) ,$$

the set of Sisu latent/state information

$$( {z}_{( i , j )}^{0} or {\{ {z}_{( i , j )}^{m , k , 0} \}}_{∀ i , j , m , k} )$$

output by the CNN as described in relation to FIG. 7, and may further receive a set of DMRS information 801 including a transmitted DMRS symbol and/or signal (x_{dmrs}), a received and/or observed DMRS signal (y_{dmrs}), and a measure of SNR associated with REs of each of the plurality of PRBs, for each of the set of PRGs, and for each of the set of MIMO layers. The refinement network 810, in some aspects, may include a fixed number (e.g., 3-10) of refinement units (e.g., a set of refinement units including refinement unit 811, refinement unit 813, and refinement unit 819) or may include iterating a single refinement unit (e.g., as in a recurrent network) a fixed number of times or until a convergence criteria or condition has been met (e.g., a ΔH or

$$\frac{Δ H}{H}$$

over the refinement unit that is below a threshold value).

Each refinement unit (e.g., each of the refinement units 811, 813, and 819), in some aspects, may include similar functions or MT sub-units. For example, the refinement unit 811, in some aspect, may include a likelihood module 820 that generates a gradient (e.g., ∇_{y|H}_{^{τ}}_{,x}, where H^{τ} is an input channel estimate for a current step/refinement unit) used to refine the channel estimation, an encoder 830 trained to update the latent/state information z^{τ} to z^{τ+1} based on the gradient generated by the likelihood module 820, and a decoder 840 trained to update the channel estimation H^{τ} to H^{τ+1} based on the updated latent/state information z^{τ+1} and the gradient generated by the likelihood module 820. In some aspects, each refinement unit may be associated with a corresponding set of MT weights θₙ, n∈1, . . . , N, where N is the total number of refinement units. For a recurrent network, in some aspects, each refinement unit may be associated with a same set of MT weights θ. The output of a set of T refinement units of the refinement network 810, in some aspects may include a channel estimate H^{T} and latent/state information z^{T}, where the output may be used as input for a subsequent channel estimation for a subsequent (e.g., next or adjacent) slot and where the channel estimate may be used for decoding data associated with a current slot.

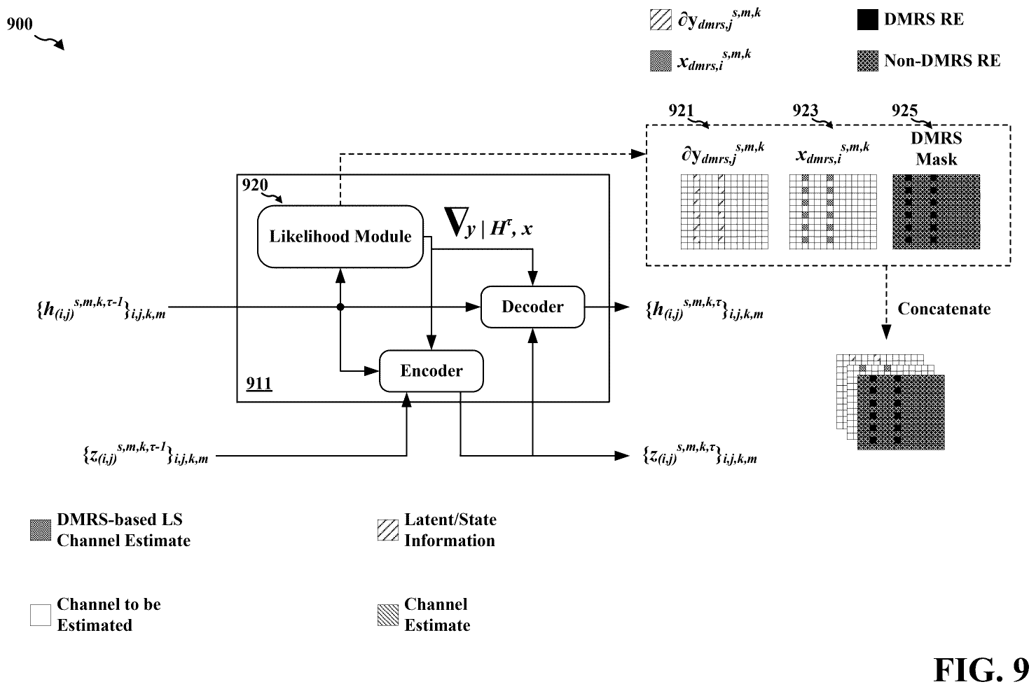

FIG. 9 is a diagram 900 illustrating the generation of the gradient at a likelihood module 920 of a single refinement unit 911 in accordance with some aspects of the disclosure. In some aspects, the observations (e.g., the measured DMRS) are sparse and the feedback/information from the likelihood module is also sparse. Each Tx-Rx pair, in some aspects, may be associated with a gradient for its own (SISO) channel and/or layer component. For example, the likelihood module may output the pilot symbols 923 (e.g., the transmitted signal associated with the transmitting antenna,

$${\{ {x}_{dmrs , i}^{s , m , k} \}}_{∀ i , m , k}$$

for a current slot s), a residual 921 based on the received signal

$${\{ δ {y}_{dmrs , j}^{s , m , k , τ} \}}_{∀ j , m , k} ,$$

for a current H^{τ} and a current slot s), and a DMRS mask 925 (e.g., an indication of the DMRS pattern associated with the PRBs or PRG associated with the DMRS transmission). In some aspects, the residual based on the received signal,

$${\{ δ {y}_{dmrs , j}^{s , m , k , τ} \}}_{∀ j , m , k} ,$$

may be calculated as

$${\{ \frac{\partial ln P ( y \vert {H}^{τ} , x )}{\partial {h}_{( i , j )}^{τ}} \}}_{∀ i , j}$$

and may be represented as

$${[ {∇}_{y \vert {H}^{τ} , x} ]}_{i , j} ,$$

which may be proportional to

$${\{ \frac{{{x}_{i} ( y - {H}^{τ} x )}_{j}^{H}}{{σ}^{2}} \}}_{∀ i , j} or {\{ \frac{{x}_{i} * δ {y}_{j}^{H}}{{σ}^{2}} \}}_{∀ i , j} .$$

The different components (e.g., the residual 921, the pilot symbols 923, and the DMRS mask 925) output by (e.g., produced and/or associated with) the likelihood module 920, in some aspects, may be concatenated along the channel dimension.

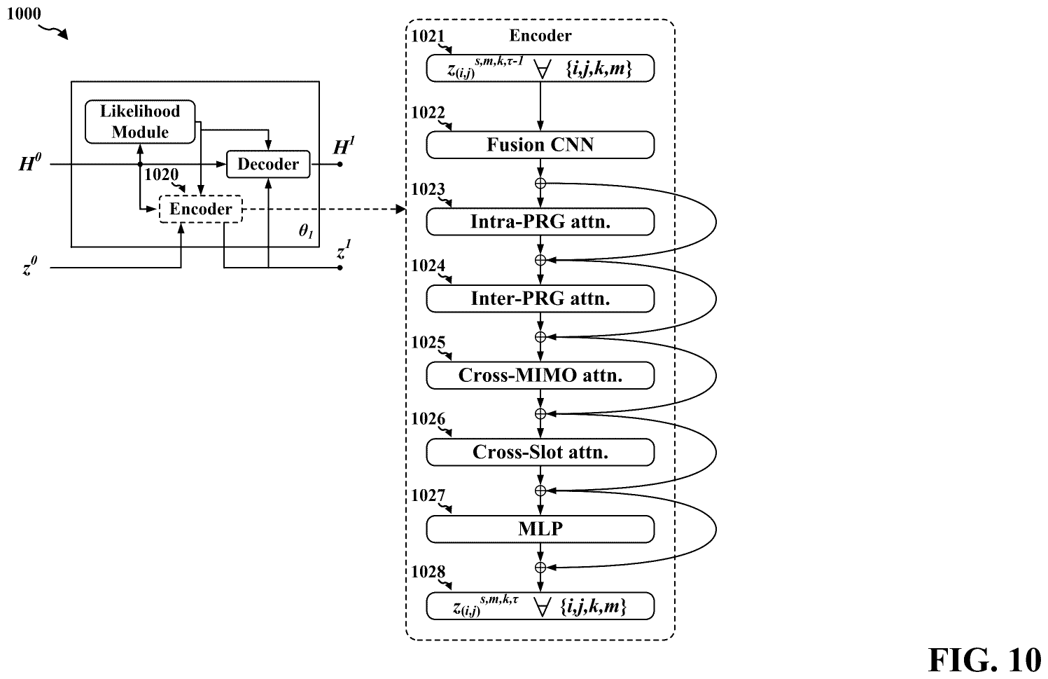

FIG. 10 is a diagram 1000 illustrating components of an encoder 1020 in accordance with some aspects of the disclosure. The encoder 1020, in some aspects, may be associated with an input 1021 which may include a current channel estimation

$${\{ {h}_{( i , j )}^{m , k} \}}_{∀ i , j , m , k}$$

for a received transmission for a current slot (and, in some aspects, for an immediately previous slot

$${\{ {h}_{( i , j )}^{m , k , - 1} \}}_{∀ i , j , m , k} ) ,$$

a current latent/state information

$${\{ {z}_{( i , j )}^{m , k} \}}_{∀ i , j , m , k}$$

for a received transmission for a current slot (and, in some aspects, for an immediately previous slot

$${\{ {z}_{( i , j )}^{m , k , - 1} \}}_{∀ i , j , m , k} ) ,$$

as well as the output of the likelihood module as described in relation to FIG. 9. The encoder 1020 may include a plurality of modules (MT networks and or algorithms) to perform different refinements on the latent/state information (e.g., the latent/state information received in input 1021, or a current and/or intermediate latent/state information based on previously performed refinements within the encoder 1020).

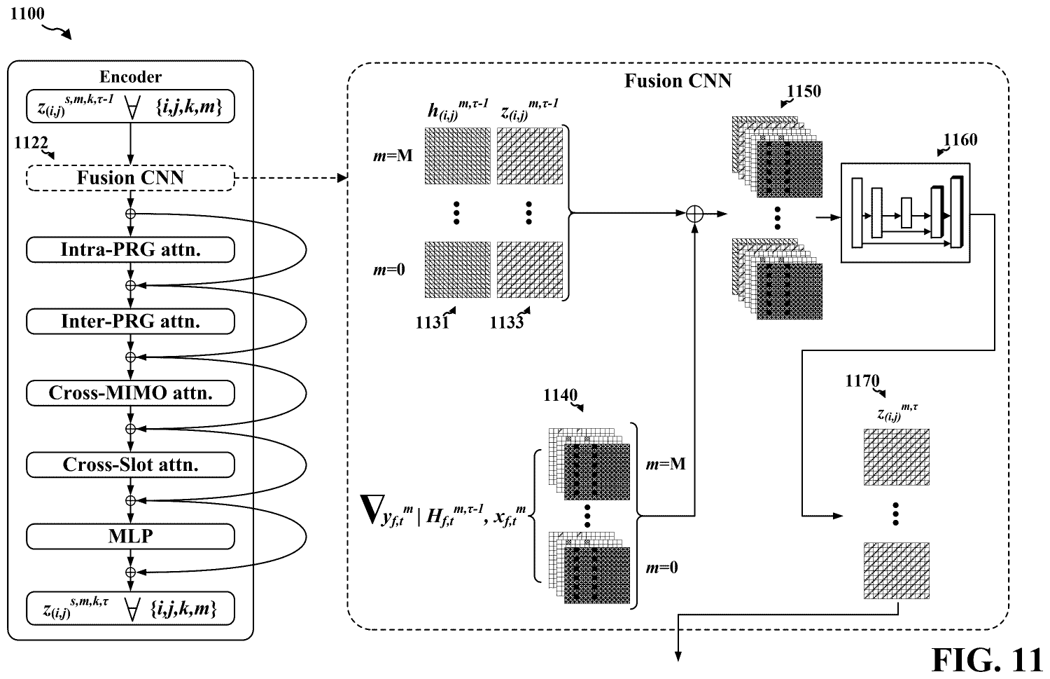

The plurality of modules is described below in more detail in relation to FIGS. 11-17. At a first level of generalization, the encoder may include a fusion CNN module 1022, an intra-PRG attention module 1023, an inter-PRG attention module 1024, a cross-MIMO attention module 1025, a cross-slot attention module 1026, and an MLP module 1027 used to produce output 1028 (e.g.,

$${\{ {z}_{( i , j )}^{m , k , τ + 1} \}}_{∀ i , j , m , k} ) .$$

The fusion CNN module 1022, in some aspects, may be used to update the plurality of sets of SISO latent/state information (the plurality of

$${z}_{( i , j )}^{m , k , 0} ,$$

where each

$${z}_{( i , j )}^{m , k , 0}$$

may include a set of multiple values such as a value for each RE in a PRB) based on the gradient information from the likelihood module. In some aspects, the intra-PRG attention module 1023 may be used to update the plurality of sets of SISO latent/state information based on sets of SISO latent/state information for PRBs in a same PRG (e.g., PRGₖ) associated with a same layer (e.g., Txⁱ-Rx^{j} pair) in the plurality of sets of SISO latent/state information. The inter-PRG attention module 1024, in some aspects, may be used to update, if the set of PRGs includes a plurality of PRGs, the plurality of sets of SISO latent/state information based on sets of SISO latent/state information for PRBs in the set of PRGs associated with a same layer in the plurality of sets of SISO latent/state information. In some aspects, the cross-MIMO attention module 1025 may be used to update, if the set of layers comprises a plurality of layers, the plurality of sets of SISO latent/state information based on sets of SISO latent/state information for PRBs in the set of PRGs associated with a set of layers in the plurality of sets of SISO latent/state information. The cross-slot attention module 1026, in some aspects, may be used to update the plurality of sets of SISO latent/state information based on a second plurality of sets of SISO latent/state information associated with a first transmission transmitted in a previous slot (the plurality of

$${z}_{( i , j )}^{m , k , - 1}$$

that are provided as described in relation to FIG. 7 from a previous iteration of the cross-slot channel estimation). The output 1028, in some aspects, may then be produced based on the MLP module 1027.

FIG. 11 is a diagram 1100 illustrating a fusion CNN 1122 of an encoder in accordance with some aspects of the disclosure. The fusion CNN 1122, in some aspects, may fuse the gradient information from the likelihood module into the latent/state information (e.g., a hidden state variable). In some aspects, the fusion CNN 1122 may introduce information regarding multiplexing MIMO phenomena to the model. The fusion CNN 1122, in some aspects, may be based on a MT network configured to accept input, and produce output, for a particular antenna port pair (e.g., a Txⁱ-Rx^{j} pair or a SISO channel) and a particular PRG (e.g., a PRGₖ) and may be applied independently for each antenna port pair for each PRG.

The input to the fusion CNN 1122 for a particular antenna port pair (e.g., a Txⁱ-Rx^{j} pair or a SISO channel) and a particular PRG (e.g., a PRGₖ), in some aspects, may include the input SISO channel estimates 1131 (e.g.,

$${\{ {h}_{( i , j )}^{m , k , τ - 1} \}}_{∀ m} )$$

and the input SISO latent/state information 1133 (e.g.,

$${\{ {z}_{( i , j )}^{m , k , τ - 1} \}}_{∀ m} )$$

for the current refinement unit, as well as the output of the likelihood module 1140 (e.g.,

$$[ {x}_{dmrs , i}^{m , k} , δ {y}_{dmrs , j}^{m , k} , {∇}_{y \vert {H}_{( i , j )}^{m , k , τ} , {x}_{( i , j )}^{m , k}} ] ) .$$

The fusion CNN 1122 may concatenate the input information and provide the concatenated input 1150 to a CNN 1160 (as an example of a machine-trained (MT) network or neural network) to produce a first updated set of latent/state information 1170 (e.g.,

$${\{ {z}_{( i , j )}^{m , k , τ} \}}_{∀ m} ) .$$

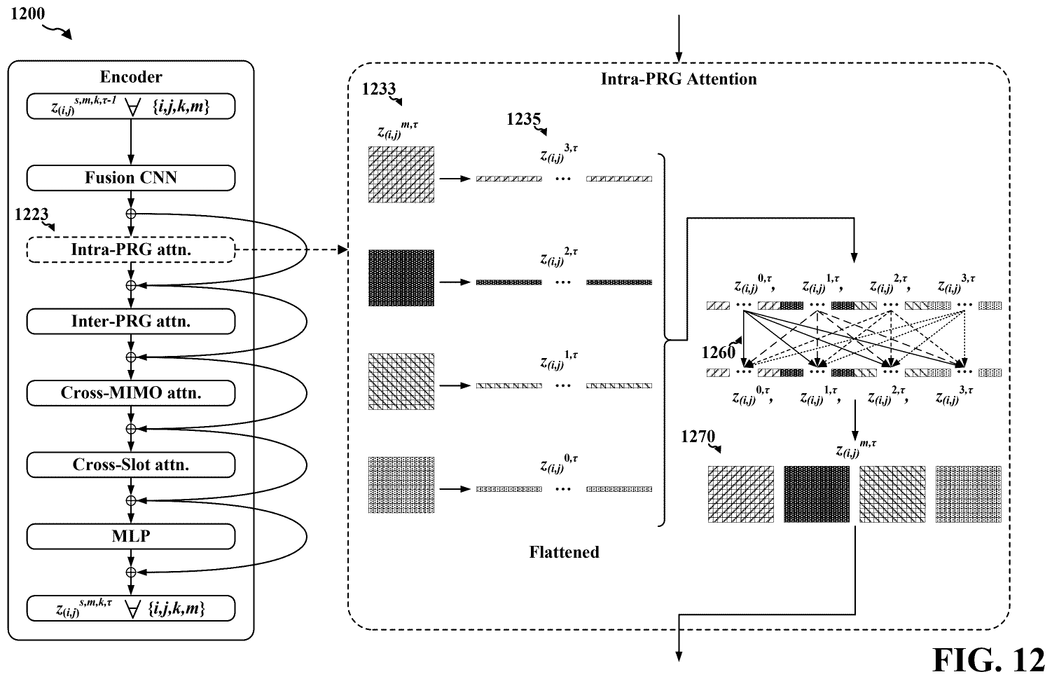

FIG. 12 is a diagram 1200 illustrating an intra-PRG attention module 1223 of an encoder in accordance with some aspects of the disclosure. The intra-PRG attention module 1223 may, in some aspects, receive the output of the fusion CNN (e.g., corresponding to fusion CNN 1122 of FIG. 11) as input 1233 (e.g.,

$${\{ {z}_{( i , j )}^{m , k , τ - 1} \}}_{∀ m} ) .$$

The intra-PRG attention module may produce “flattened” sets of latent/state information 1235 (e.g.,

$${\{ {z}_{( i , j )}^{m , τ} \}}_{∀ m} )$$

that are each a 1-dimensional (1D) representation of the 2-dimensional (2D) latent/state information for use in attention-based ML algorithms. The flattened sets of latent/state information 1235 may then be used for an intra-PRG attention operation 1260 updating the latent/state information 1235 to produce an updated output set of latent/state information 1270 (e.g.,

$${\{ {z}_{( i , j )}^{m , τ} \}}_{∀ m} )$$

The intra-PRG attention module 1223, in some aspects, may be applied for each PRG and for each layer associated with the current slot.

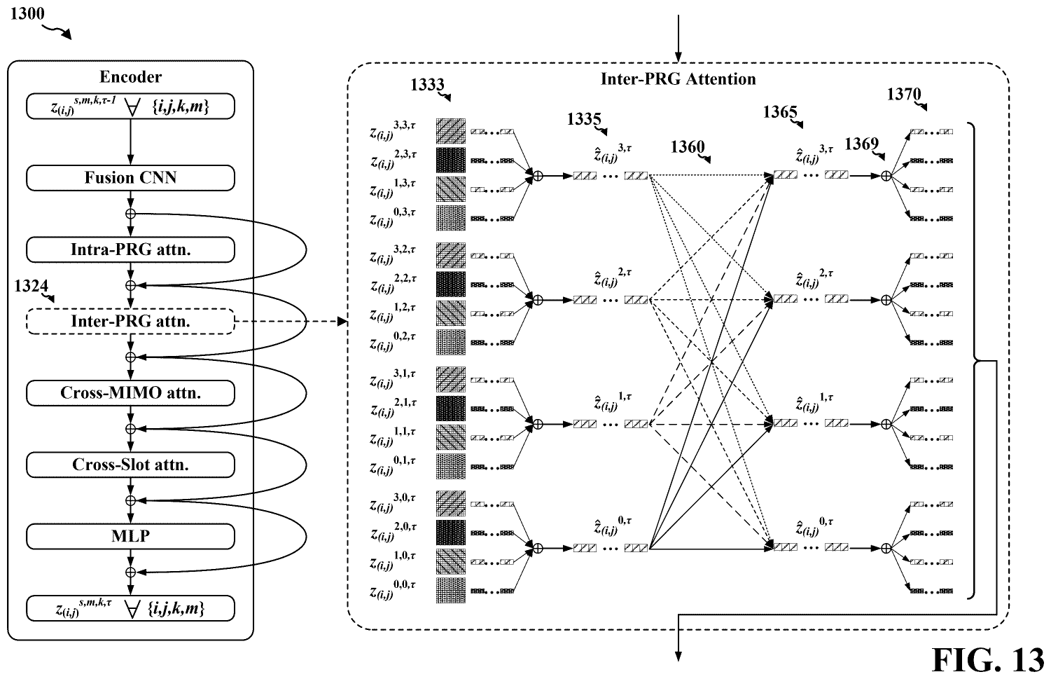

FIG. 13 is a diagram 1300 illustrating an inter-PRG attention module 1324 of an encoder in accordance with some aspects of the disclosure. In some aspects, inter-PRG attention facilitates information exchange across different PRGs. The inter-PRG attention module 1324 may, in some aspects, receive the output of the intra-PRG attention module (e.g., corresponding to the intra-PRG attention module 1223 of FIG. 12) applied to, or for, a plurality of PRGs as input 1333 (e.g.,

$${\{ {z}_{( i , j )}^{m , k , τ} \}}_{∀ m , k} ) .$$

The inter-PRG attention module may produce flattened, averaged, and/or mean-pooled sets of latent/state information 1335 (e.g.,

$${\{ {\hat{z}}_{( i , j )}^{k , τ} \}}_{∀ k} )$$

that are each a 1-dimensional (1D) representation of the 2-dimensional (2D) latent/state information for use in attention-based ML algorithms. The flattened, averaged, and/or mean-pooled sets of latent/state information 1335 may then be used for an intra-PRG attention operation 1360 updating the latent/state information 1335 to produce updated flattened, averaged, and/or mean-pooled sets of latent/state information 1365 (e.g.,

$${\{ {\hat{z}}_{( i , j )}^{k , τ} \}}_{∀ k} ) .$$

The updated flattened, averaged, and/or mean-pooled sets of latent/state information 1365 may then be used (e.g., added as a residual) at 1369 to update the input 1333 (e.g.,

$${\{ {z}_{( i , j )}^{m , k , τ} \}}_{∀ m , k} )$$

to produce a set of output SISO latent/state information 1370 for each of the input PRGs. The inter-PRG attention module 1324, in some aspects, may be applied for each layer independently and may use input associated with each of the K PRGs associated with the current slot. set of output set of latent/state information 1270 (e.g.,

$${\{ {z}_{( i , j )}^{m , τ} \}}_{∀ m} ) .$$

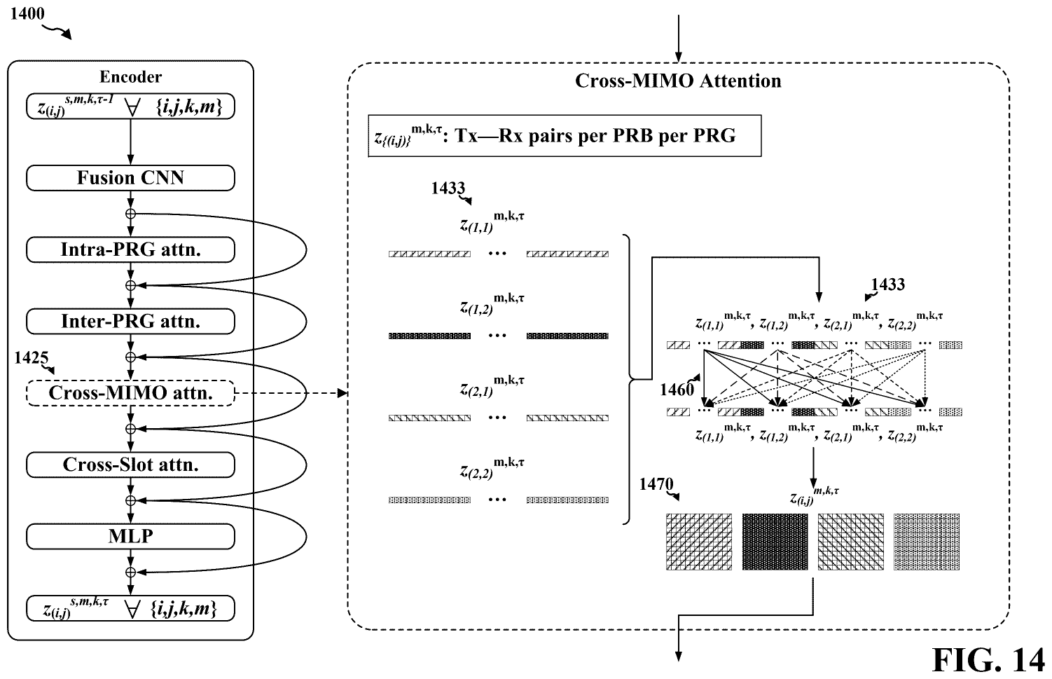

FIG. 14 is a diagram 1400 illustrating a cross-MIMO attention module 1425 of an encoder in accordance with some aspects of the disclosure. In some aspects, cross-MIMO attention models interactions and/or correlations between different transmission links (MIMO layers or Txⁱ-Rx^{j} antenna port pairs) for a particular PRB within a PRG. The cross-MIMO attention, in some aspects, may model the correlation in an equivariant way. The cross-MIMO attention module 1425 may, in some aspects, receive the output (e.g., the SISO latent/state information of the inter-PRG attention module 1324 for a same PRB associated with a plurality of MIMO layers) as input and produce flattened latent/state information 1433 (e.g.,

$${\{ {z}_{( i , j )}^{m , k , τ} \}}_{∀ m} ) .$$

The flattened sets of latent/state information 1433 may then be used for a cross-MIMO attention operation 1460 updating the latent/state information 1433 to produce an updated output set of latent/state information 1470 (e.g.,

$${\{ {z}_{( i , j )}^{m , k , τ} \}}_{∀ i , j} ) .$$

The cross-MIMO attention module 1425, in some aspects, may be applied for each PRB associated with the current slot.

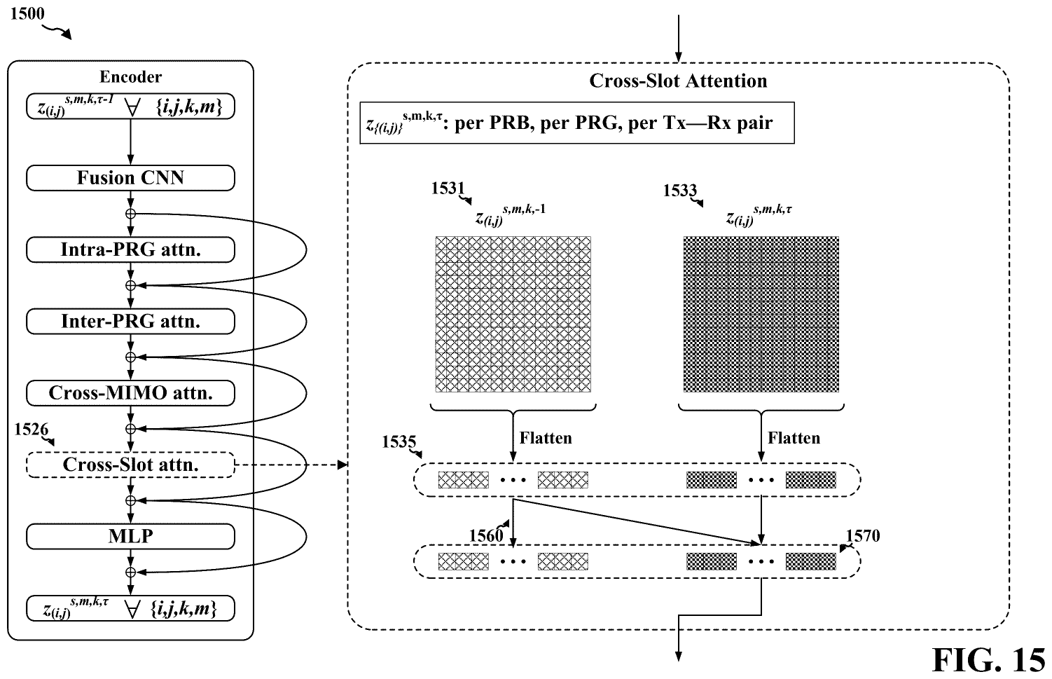

FIG. 15 is a diagram 1500 illustrating a cross-slot attention module 1526 of an encoder in accordance with some aspects of the disclosure. In some aspects, the cross-slot attention models interactions and/or correlations between a same PRB adjacent slots, e.g., the cross-slot attention module 1526 may be used for each PRB in each PRG in each MIMO associated with a transmission in a current slot. For example, the cross-slot attention module 1526 may accept as input the latent/state information 1531 (e.g.,

$${z}_{( i , j )}^{m , k , - 1} or {z}_{( i , j )}^{s - 1 , m , k , T} )$$

for a particular PRB (e.g., for a particular pair of values (m, k)) in a previous (and adjacent) slot (e.g., a first slot 501 or “slot 0” as in FIG. 5) and the output latent/state information 1533 (e.g.,

$${z}_{( i , j )}^{m , k , τ} or {z}_{( i , j )}^{s , m , k , τ} )$$

for the particular PRB in the current slot (e.g., a second slot 503 or “slot 1” as in FIG. 5).

The cross-slot attention module 1526 may generate a set of flattened latent/state information 1535 from the input the latent/state information 1531 and the input the latent/state information 1533. In some aspects, the cross-slot attention module 1526 may then perform a causal cross slot attention operation 1560 to produce an output set of latent/state information 1570. The causal cross slot attention operation 1560, in some aspects, allows for the latent/state information of each slot to be affected by the latent/state information of slots that are no later than the slot. For example, the latent/state information 1531 associated with slot 0 may be used to update the latent/state information 1531 associated with slot 0 and the latent/state information 1533 associated with slot 1, while the latent/state information 1533 associated with slot 1 is used to update the latent/state information 1533 associated with slot 1 but not the latent/state information 1531 associated with slot 0. In some aspects, the cross-slot attention operation may be considered a sequence to sequence mapping that is restricted to causal correlations as described previously.

The output of the cross-slot attention module 1526, in some aspects, may be provided to a multi-layer perceptron (MLP) (e.g., the MLP 1027 of FIG. 10). In some aspects, the MLP may be a pointwise MLP. The pointwise MLP may act independently on each of the

$${z}_{( i , j )}^{m , k , τ}$$

(e.g., per-PRB, per Txⁱ-Rx^{j} antenna port pair). The MLP, in some aspects, may be an MLP having two or more layers.

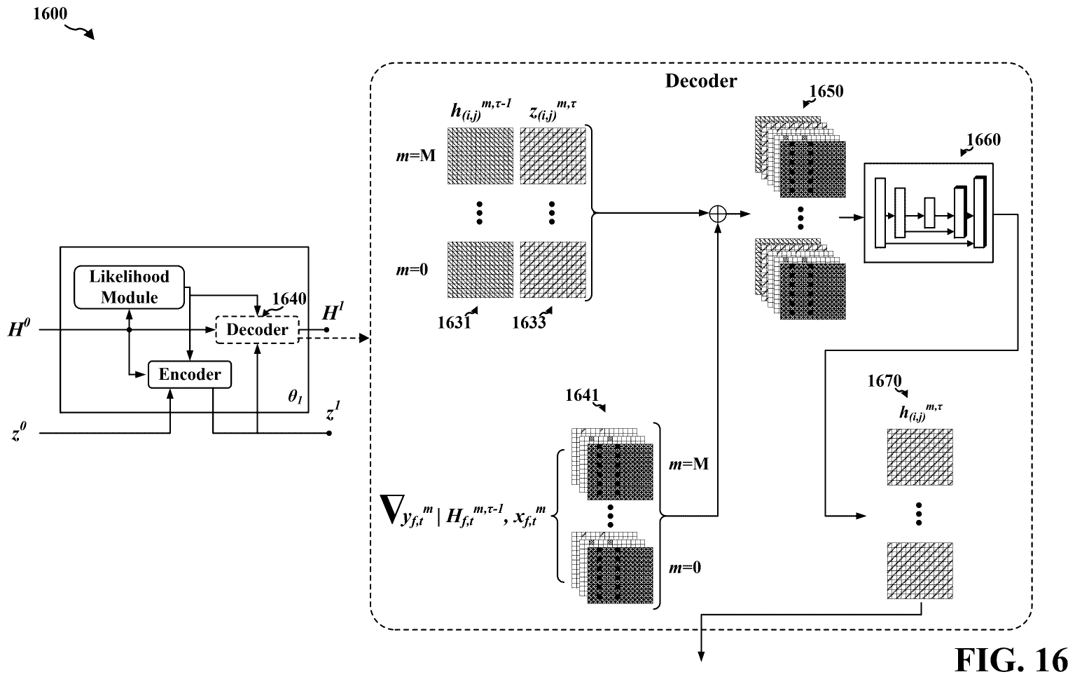

As the output of the channel estimation for a current slot is dependent on the channel estimation (and latent/state information) for a previous slot, the training of the ML network as described in relation to FIG. 6 may be based on a loss function based on the residual for both a first channel estimation performed for the first (or previous) slot and a second channel estimation performed for the second (or current) slot which may not be used for MT networks that do not perform cross-slot channel estimations. FIG. 16 is a diagram 1600 illustrating a decoder 1640 in accordance with some aspects of the disclosure. The operation of the decoder 1640 may be based on a MT network configured to accept input, and produce output, for a particular antenna port pair (e.g., a Txⁱ-Rx^{j} pair or a SISO channel) and a particular PRG (e.g., a PRGₖ) which may be applied independently for each antenna port pair for each PRG. The input to the decoder 1640 for a particular antenna port pair (e.g., a Txⁱ-Rx^{j} pair or a SISO channel) and a particular PRG (e.g., a PRGₖ), in some aspects, may include the input SISO channel estimates 1631 (e.g.,

$${\{ {h}_{( i , j )}^{m , k , τ - 1} \}}_{∀ m} )$$

and the output SISO latent/state information 1633 (e.g.,

$${\{ {z}_{( i , j )}^{m , k , τ} \}}_{∀ m} )$$

of the encoder for the current refinement unit, as well as the output 1641 of the likelihood module (e.g.,

$$[ {x}_{dmrs , i}^{m , k} , δ {y}_{dmrs , j}^{m , k} , {∇}_{y \vert {H}_{( i , j )}^{m , k , τ} , {x}_{( i , j )}^{m , k}} ] ) .$$

The decoder 1640 may concatenate the input information and provide the concatenated input 1650 to a CNN 1660 (as an example of a machine-trained (MT) network or neural network) to produce an updated set of channel estimations 1670 (e.g.,

$${\{ {h}_{( i , j )}^{m , k , τ} \}}_{∀ m} ) .$$

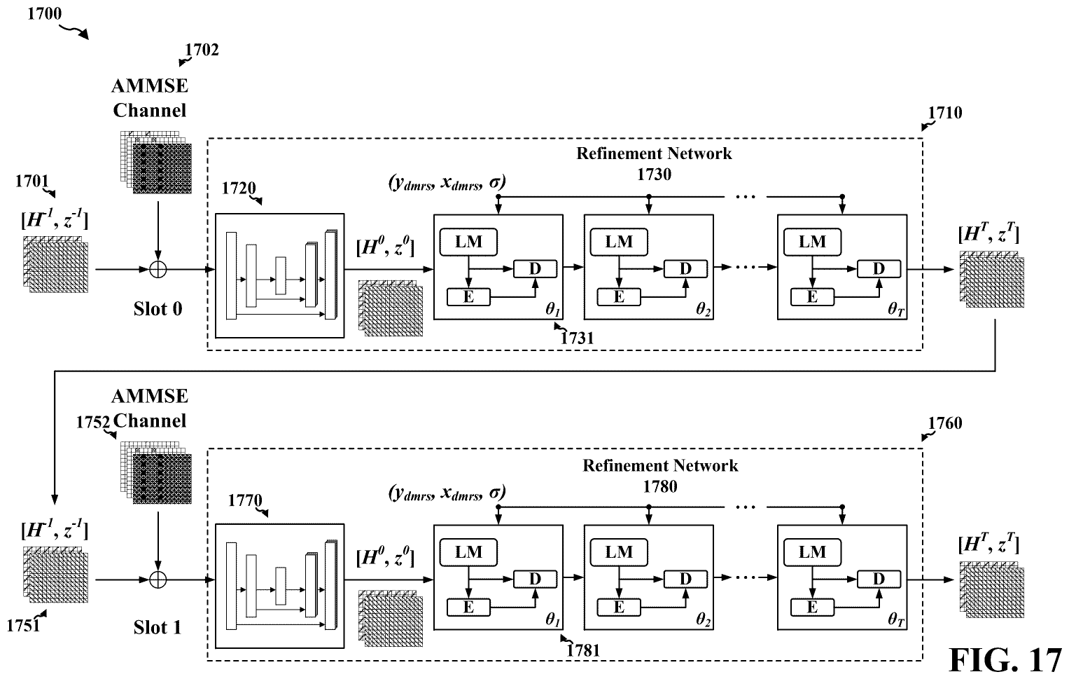

FIG. 17 is a diagram 1700 illustrates a MT network associated with a recurrent equivariant inference machine for refining AMMSE cross-slot channel estimation in accordance with some aspects of the disclosure. The MT network 1710 may be applied to a first set of inputs 1701 including a channel estimation (e.g., a set of SISO channel estimations) and latent/state information (e.g., a set of SISO latent/state information) that, for an initial channel estimation, may be initialized to 0 (or some other constant) or random values and for a non-initial channel estimation is based on a previous application of the MT network. The MT network 1710 may further be applied to a second set of inputs 1702 associated with classical channel estimation, e.g., one or more of a set of DMRS tones, a DMRS mask, SNR information, and/or an AMMSE channel estimation. The MT network 1710, based on the first set of inputs 1701 and the second set of inputs 1702 for a first slot, may produce a set of SISO channel estimates and a set of SISO latent/state information making up a channel estimation for a first MIMO transmission (e.g., associated with a set of PRGs transmitted) within the first slot. The MT network 1710, in some aspects, may include a CNN 1720 and the refinement network 1730 (e.g., a recurrent neural network and/or pseudo-recurrent neural network) that includes a plurality of refinement units (e.g., refinement unit 1731) that may be identical or similar as illustrated in relation to refinement network 810 of FIG. 8. The output of the MT network 1710 may be provided as the input data set 1751 (corresponding to the set of input 1701 provided to the MT network 1710).

The MT network 1760 (e.g., another instantiation of the MT network 1710), based on the first set of inputs (e.g., the input data set 1751) and a second set of inputs 1752 for a second slot, may produce a set of SISO channel estimates and a set of SISO latent/state information making up a channel estimation for a first MIMO transmission (e.g., associated with a set of PRGs transmitted) within the second slot. Accordingly, the second channel estimate produced by the MT network 1760 will be based on the channel estimation associated with the previous slot. The MT network 1760, in some aspects, may include a CNN 1770 and the refinement network 1780 (e.g., a recurrent neural network and/or pseudo-recurrent neural network) that includes a plurality of refinement units (e.g., refinement unit 1781) that may be identical or similar as illustrated in relation to refinement network 810 of FIG. 8. The output of the MT network 1760 may be provided as the input data set for a channel estimation using the MT network for a subsequent (next) slot.

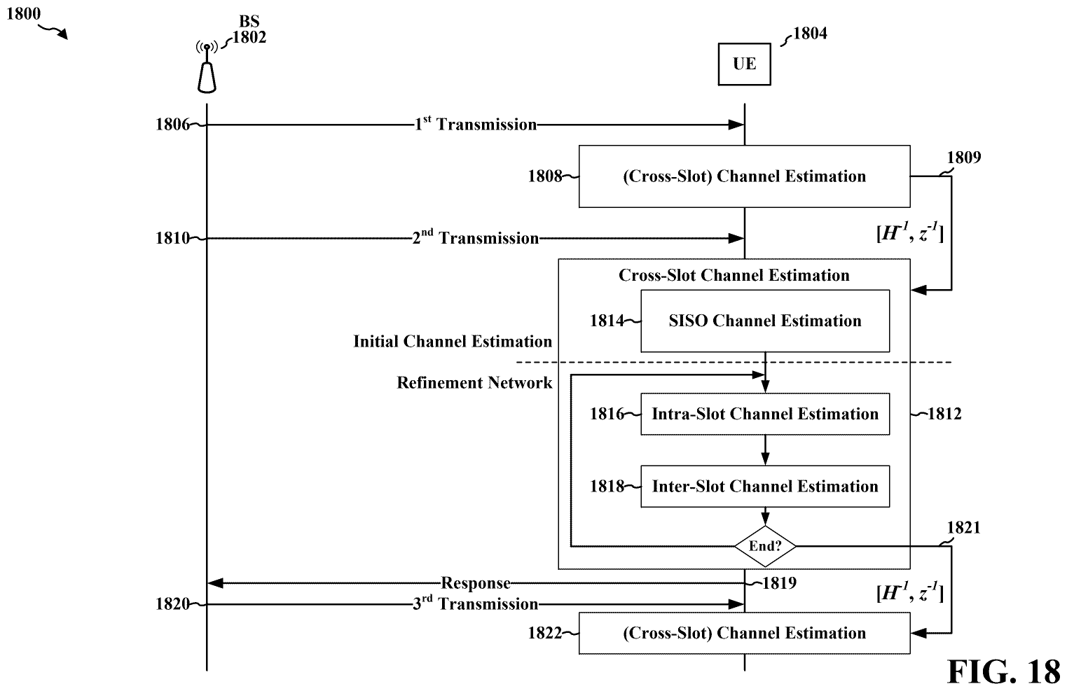

FIG. 18 is a call flow diagram 1800 illustrating a method of wireless communication in accordance with some aspects of the disclosure. The method is illustrated in relation to a base station 1802 (e.g., as an example of a network device or network node that may include one or more components of a disaggregated base station) in communication with a UE 1804 (e.g., as an example of a wireless device). The functions ascribed to the base station 1802, in some aspects, may be performed by one or more components of a network entity, a network node, or a network device (a single network entity/node/device or a disaggregated network entity/node/device as described above in relation to FIG. 1). Similarly, the functions ascribed to the UE 1804, in some aspects, may be performed by one or more components of a wireless device supporting communication with a network entity/node/device. Accordingly, references to “transmitting” in the description below may be understood to refer to a first component of the base station 1802 (or the UE 1804) outputting (or providing) an indication of the content of the transmission to be transmitted by a different component of the base station 1802 (or the UE 1804). Similarly, references to “receiving” in the description below may be understood to refer to a first component of the base station 1802 (or the UE 1804) receiving a transmitted signal and outputting (or providing) the received signal (or information based on the received signal) to a different component of the base station 1802 (or the UE 1804).

The base station 1802 may transmit, and the UE 1804 may receive, a first transmission 1806. The first transmission 1806, in some aspects, may be a MIMO transmission (e.g., associated with multiple transmit antenna-receive antenna pairs) over a set of PRGs. The first transmission 1806 may be associated with a per-PRG pre-coding, a DMRS pattern, a number of resource blocks (e.g., PRBs) in the PRGs, and a first number of layers (e.g., transmit antenna-receive antenna pairs). In some aspects, the DMRS patter and the number of PRBs in a PRG may be the same for the PRGs in a same slot. The UE 1804, at 1808, may perform the cross-slot channel estimation and latent/state information generation (without information from a channel estimation for a previous slot) using the MT network. For example, the UE 1804 may use the MT network 1710 of FIG. 17 to perform a channel estimation and generate latent/state information.

In a next slot, the base station 1802 may transmit, and the UE 1804 may receive, a second transmission 1810. The second transmission 1810, in some aspects, may be a MIMO transmission (e.g., associated with multiple transmit antenna-receive antenna pairs) over a second set of PRGs. The second transmission 1810 may be associated with a per-PRG pre-coding, a DMRS pattern, a number of resource blocks in the PRGs, and a second number of layers (e.g., transmit antenna-receive antenna pairs) where the per-PRG pre-coding, the DMRS pattern, the number of resource blocks in the PRGs, and the second number of layers may be different between the second slot and the first slot.

The UE 1804, at 1812, may perform, based on the output 1809 of the cross-slot channel estimation and latent/state information generation performed at 1808, the cross-slot channel estimation and latent/state information generation (without information from a channel estimation for a previous slot) using the MT network. The cross-slot channel estimation at 1812, in some aspects, may include performing, at 1814, a SISO channel estimation for each PRG for each layer of the second transmission (e.g., the set of SISO channel estimations described in relation to FIG. 7). The SISO channel estimations produced at 1814 may then be provided to a refinement network for an intra-slot channel estimation (e.g., a refinement of latent/state information for a channel estimation) at 1816 (e.g., the intra-slot refinements associated with the fusion CNN module 1022, the intra-PRG attention module 1023, the inter-PRG attention module 1024, and the cross-MIMO attention module 1025 of FIG. 10) and an inter-slot channel estimation (e.g., a refinement of latent/state information for a channel estimation) at 1818 (e.g., the cross-slot attention module 1026 of FIG. 10). The inter-slot channel estimation at 1816 and the inter-slot channel estimation at 1818 may be repeated until a fixed number of iterations have been performed or convergence criteria have been met. For example, the UE 1804 may use the MT network 1760 of FIG. 17 to perform a channel estimation and generate latent/state information. The UE 1804, in some aspects may, based on the channel estimation performed at 1812, decode the second transmission 1810 and transmit a response (e.g., an ACK or NACK) 1819.

In a next slot, the base station 1802 may transmit, and the UE 1804 may receive, a third transmission 1820. The third transmission 1820, in some aspects, may be a MIMO transmission (e.g., associated with multiple transmit antenna-receive antenna pairs) over a third set of PRGs. The third transmission 1820 may be associated with a per-PRG pre-coding, a DMRS pattern, a number of resource blocks in the PRGs, and a third number of layers (e.g., transmit antenna-receive antenna pairs) where the per-PRG pre-coding, the DMRS pattern, the number of resource blocks in the PRGs, and the third number of layers may be different between the second slot and the third slot. The UE 1804, at 1822, may perform, based on the output 1821 of the cross-slot channel estimation and latent/state information generation performed at 1812, the cross-slot channel estimation and latent/state information generation (without information from a channel estimation for a previous slot) using the MT network.

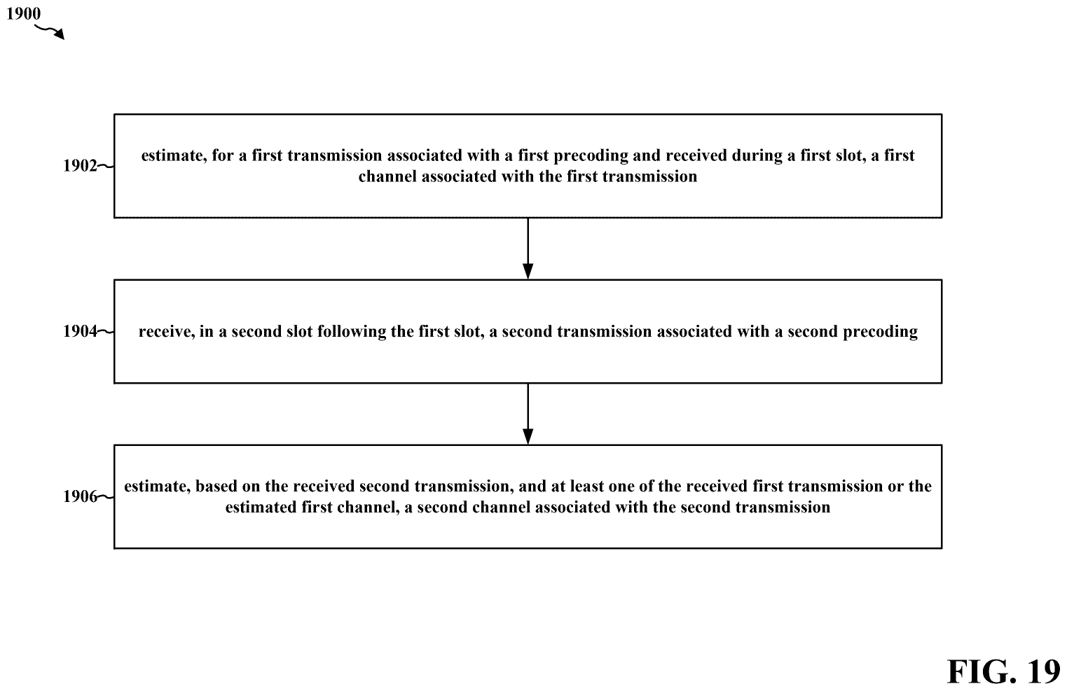

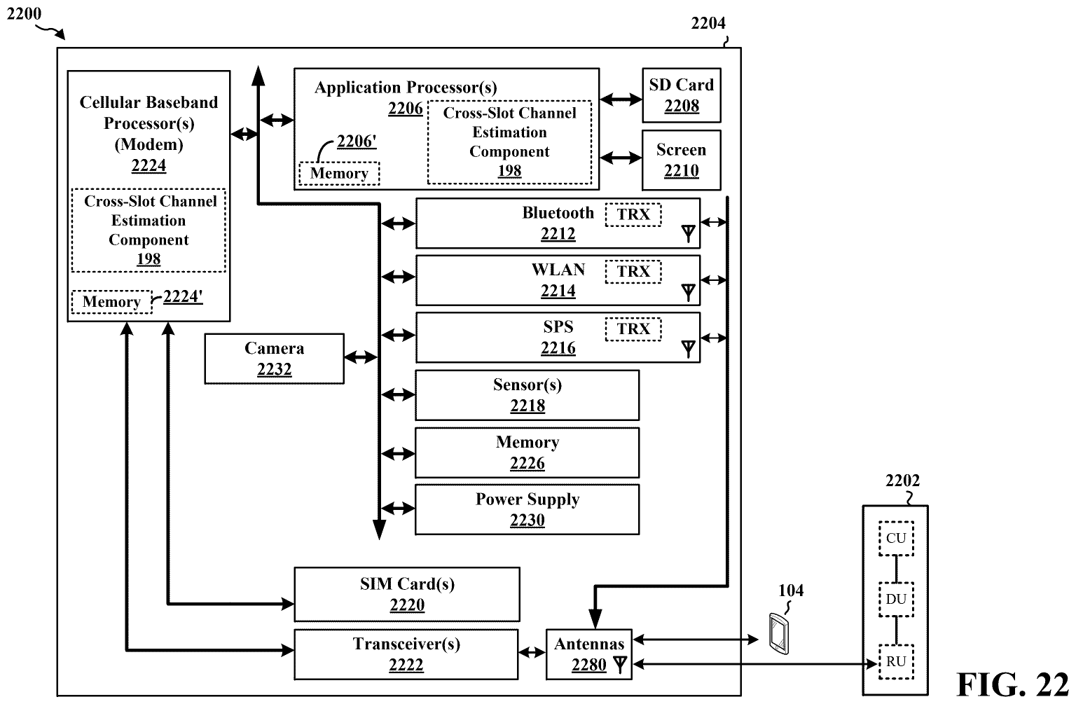

FIG. 19 is a flowchart 1900 of a method of wireless communication. The method may be performed by a UE (e.g., the UE 104, 404, 1804; the apparatus 2204). At 1902, the UE may estimate, for a first transmission in a first slot, a first channel associated with the first transmission. For example, 1902 may be performed by application processor(s) 2206, cellular baseband processor(s) 2224, transceiver(s) 2222, antenna(s) 2280, and/or cross-slot channel estimation component 198 of FIG. 22. In some aspects, the first transmission may be associated with a first precoding. The first transmission, in some aspects, may further be associated with a first DMRS pattern, a first number of PRBs in at least a first PRG associated with the first precoding, a first SCS, and a first number of layers. In some aspects, the estimation of the first channel may be performed using a neural network. The neural network, in some aspects, may include at least a CNN and one of a refinement network or RNN. For example, referring to FIGS. 17 and 18, the UE 1804 may receive a first transmission 1806 and perform, at 1808, a channel estimate using the MT network 1710.

At 1904, the UE may receive, in a second slot following the first slot, a second transmission associated with a second precoding. For example, 1904 may be performed by application processor(s) 2206, cellular baseband processor(s) 2224, transceiver(s) 2222, antenna(s) 2280, and/or cross-slot channel estimation component 198 of FIG. 22. In some aspects, the second precoding associated with the second transmission may be different from the first precoding associated with the first transmission. The second transmission, in some aspects, may further be associated with a second DMRS pattern, a second number of PRBs in at least a second PRG associated with the second precoding, a second SCS, and a second number of layers. In some aspects, at least one of (1) the second DMRS pattern may be different from the first DMRS pattern, (2) the second number of PRBs may be different from the first number of PRBs, (3) the second SCS may be different from the first SCS, or (4) the second number of layers may be different from the first number of layers. For example, referring to FIG. 18, the UE 1804 may receive the second transmission 1810.

At 1906, the UE may estimate, based on the received second transmission and at least one of the received first transmission or the estimated first channel, a second channel associated with the second transmission. For example, 1906 may be performed by application processor(s) 2206, cellular baseband processor(s) 2224, transceiver(s) 2222, antenna(s) 2280, and/or cross-slot channel estimation component 198 of FIG. 22. In some aspects, the estimation of the second channel may not be based on an explicit indication that the second precoding is different from the first precoding. In some aspects, the estimation of the second channel may be performed using a neural network. The neural network, in some aspects, may include at least a CNN and one of a refinement network or RNN. An input to the neural network for the estimation of the second channel, in some aspects, may include at least (1) a first estimation of the second channel based on a MMSE based on a DMRS pattern associated with the second transmission, and (2) information based on the first channel estimation performed using the neural network, wherein the information comprises the estimated first channel and state information based on at least the first channel estimation. In some aspects, the state information may further be based on a set of additional channel estimations performed using the neural network, where the set of additional channel estimations may be associated with a corresponding set of slots preceding the first slot. The input to the neural network for the estimation of the second channel, in some aspects, may further include (1) an indication of the DMRS pattern, (2) a set of DMRS tones associated with the DMRS patterns, and (3) a set of SNRs (or SNR information) associated with the second transmission. For example, referring to FIGS. 17 and 18, the UE 1804 may receive a second transmission 1810 and perform, at 1812, a channel estimation for the second transmission using the MT network 1760.

In some aspects, the estimation of the second channel using the neural network may include generating, using the CNN, a plurality of SISO channel estimates. The second transmission, in some aspects, may be associated with a set of layers, where each layer of the set of layers may be associated with a set of PRGs and where each PRG may include a plurality of PRBs. Accordingly, in some aspects, the plurality of SISO channel estimates may include a SISO channel estimate for each PRB in each layer of the set of layers. In some aspects, the state information includes a plurality of sets of SISO state information corresponding to the plurality of SISO channel estimates. The plurality of sets of SISO state information, in some aspects, includes a set of SISO state information for each PRB in each layer of the set of layers. In some aspects, the estimation of the second channel using the neural network at 1906 includes an iterative process (at the RNN) performed until a stopping condition is met. The iterative process, in some aspects, may include generating, based on a known DMRS pattern, a known transmitted DMRS symbol, and an observed and/or received DMRS signal, gradient information. The gradient information, in some aspects, may include a plurality of subsets of gradient information corresponding to the plurality of SISO channel estimates and the plurality of sets of SISO state information, where each subset of gradient information may be associated with a corresponding SISO channel estimate and a corresponding set of SISO state information (e.g., as described in relation to FIGS. 9 and 11). The iterative process, in some aspects, may further include updating the plurality of sets of SISO state information based on the gradient information and updating the plurality of sets of SISO state information based on sets of SISO state information for PRBs in a same PRG associated with a same layer in the plurality of sets of SISO state information.

The UE may determine if the set of PRGs includes a plurality of PRGs, and if so, the iterative process, in some aspects, may further include updating the plurality of sets of SISO state information based on sets of SISO state information for PRBs in the set of PRGs associated with a same layer in the plurality of sets of SISO state information. If the UE determines that the set of PRGs does not include a plurality of PRGs, the UE may determine if the set of layers includes a plurality of layers, and if so, the iterative process, in some aspects, may further include updating the plurality of sets of SISO state information based on sets of SISO state information for PRBs in the set of PRGs associated with a set of layers in the plurality of sets of SISO state information. After updating the plurality of sets of SISO state information based on sets of SISO state information for PRBs in the set of PRGs associated with a set of layers in the plurality of sets of SISO state information or determining that the set of layers does not include a plurality of layers, the iterative process, in some aspects, may further include updating the plurality of sets of SISO state information based on a second plurality of sets of SISO state information associated with the first transmission and updating the plurality of SISO channel estimates based on the gradient information and the updated plurality of sets of SISO state information. For example, referring to FIGS. 9-18, the UE 1804 may receive a second transmission 1810 and perform, at 1812, a channel estimation for the second transmission using the MT network 1760 including the modules illustrated in FIGS. 9-16.

In some aspects, the UE may decode the second transmission based on the estimated second channel and may store the decoded second transmission and/or transmit, based on the decoded second transmission and for a source of the second transmission, a response to the second transmission.

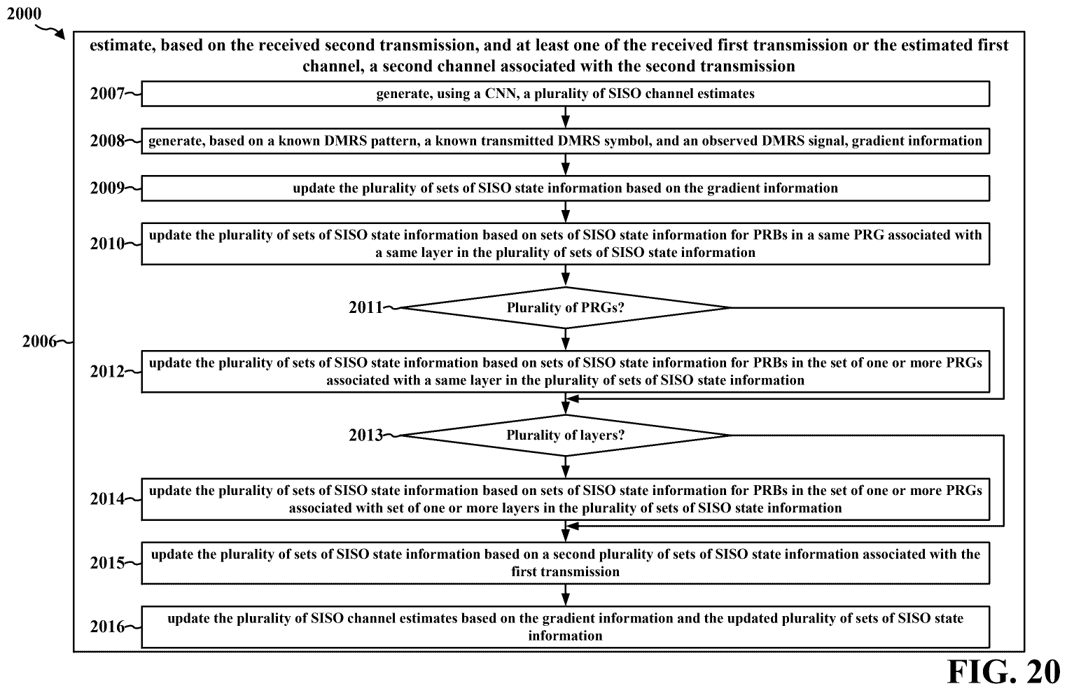

FIG. 20 is a flowchart 2000 illustrating additional sub-operations of estimating, based on the received second transmission and at least one of the received first transmission or the estimated first channel, a second channel associated with the second transmission associated with the method of wireless communication illustrated in flowchart 1900 of FIG. 19. The method may be performed by a UE (e.g., the UE 104, 404, 1804; the apparatus 2204). As described in relation to FIG. 19, the UE may estimate, for a first transmission in a first slot, a first channel associated with the first transmission. In some aspects, the first transmission may be associated with a first precoding. The first transmission, in some aspects, may further be associated with a first DMRS pattern, a first number of PRBs in at least a first PRG associated with the first precoding, a first SCS, and a first number of layers. In some aspects, the estimation of the first channel may be performed using a neural network. The neural network, in some aspects, may include at least a CNN and one of a refinement network or RNN. For example, referring to FIGS. 17 and 18, the UE 1804 may receive a first transmission 1806 and perform, at 1808, a channel estimate using the MT network 1710.

As described in relation to FIG. 19, the UE may receive, in a second slot following the first slot, a second transmission associated with a second precoding. In some aspects, the second precoding associated with the second transmission may be different from the first precoding associated with the first transmission. The second transmission, in some aspects, may further be associated with a second DMRS pattern, a second number of PRBs in at least a second PRG associated with the second precoding, a second SCS, and a second number of layers. In some aspects, at least one of (1) the second DMRS pattern may be different from the first DMRS pattern, (2) the second number of PRBs may be different from the first number of PRBs, (3) the second SCS may be different from the first SCS, or (4) the second number of layers may be different from the first number of layers. For example, referring to FIG. 18, the UE 1804 may receive the second transmission 1810.

At 2006, the UE may estimate, based on the received second transmission and at least one of the received first transmission or the estimated first channel, a second channel associated with the second transmission. For example, 2006 may be performed by application processor(s) 2206, cellular baseband processor(s) 2224, transceiver(s) 2222, antenna(s) 2280, and/or cross-slot channel estimation component 198 of FIG. 22. In some aspects, the estimation of the second channel may not be based on an explicit indication that the second precoding is different from the first precoding. In some aspects, the estimation of the second channel may be performed using a neural network. The neural network, in some aspects, may include at least a CNN and one of a refinement network or RNN. An input to the neural network for the estimation of the second channel, in some aspects, may include at least (1) a first estimation of the second channel based on a MMSE based on a DMRS pattern associated with the second transmission, and (2) information based on the first channel estimation performed using the neural network, wherein the information comprises the estimated first channel and state information based on at least the first channel estimation. In some aspects, the state information may further be based on a set of additional channel estimations performed using the neural network, where the set of additional channel estimations may be associated with a corresponding set of slots preceding the first slot. The input to the neural network for the estimation of the second channel, in some aspects, may further include (1) an indication of the DMRS pattern, (2) a set of DMRS tones associated with the DMRS patterns, and (3) a set of SNRs (or SNR information) associated with the second transmission. For example, referring to FIGS. 17 and 18, the UE 1804 may receive a second transmission 1810 and perform, at 1812, a channel estimation for the second transmission using the MT network 1760.

In some aspects, the estimation of the second channel using the neural network may include, at 2007, generating, using the CNN, a plurality of SISO channel estimates. The second transmission, in some aspects, may be associated with a set of layers, where each layer of the set of layers may be associated with a set of PRGs and where each PRG may include a plurality of PRBs. Accordingly, in some aspects, the plurality of SISO channel estimates may include a SISO channel estimate for each PRB in each layer of the set of layers. In some aspects, the state information includes a plurality of sets of SISO state information corresponding to the plurality of SISO channel estimates. The plurality of sets of SISO state information, in some aspects, includes a set of SISO state information for each PRB in each layer of the set of layers. In some aspects, the estimation of the second channel using the neural network at 2006 includes an iterative process (at the RNN) performed until a stopping condition is met. The iterative process, in some aspects, may include, at 2008, generating, based on a known DMRS pattern, a known transmitted DMRS symbol, and an observed and/or received DMRS signal and/or symbol, gradient information. The gradient information, in some aspects, may include a plurality of subsets of gradient information corresponding to the plurality of SISO channel estimates and the plurality of sets of SISO state information, where each subset of gradient information may be associated with a corresponding SISO channel estimate and a corresponding set of SISO state information (e.g., as described in relation to FIGS. 9 and 11). The iterative process, in some aspects, may further include, at 2009, updating the plurality of sets of SISO state information based on the gradient information and, at 2010, updating the plurality of sets of SISO state information based on sets of SISO state information for PRBs in a same PRG associated with a same layer in the plurality of sets of SISO state information.

The UE may determine at 2011 if the set of PRGs includes a plurality of PRGs, and if so, the iterative process, in some aspects, may further include, at 2012, updating the plurality of sets of SISO state information based on sets of SISO state information for PRBs in the set of PRGs associated with a same layer in the plurality of sets of SISO state information. If the UE determines at 2013 that the set of PRGs does not include a plurality of PRGs, the UE may determine if the set of layers includes a plurality of layers, and if so, the iterative process, in some aspects, may further include, at 2014, updating the plurality of sets of SISO state information based on sets of SISO state information for PRBs in the set of PRGs associated with a set of layers in the plurality of sets of SISO state information. After updating the plurality of sets of SISO state information based on sets of SISO state information for PRBs in the set of PRGs associated with a set of layers in the plurality of sets of SISO state information or determining at 2013 that the set of layers does not include a plurality of layers, the iterative process, in some aspects, may further include, at 2015, updating the plurality of sets of SISO state information based on a second plurality of sets of SISO state information associated with the first transmission and, at 2016, updating the plurality of SISO channel estimates based on the gradient information and the updated plurality of sets of SISO state information. For example, 2007-2016 may be performed by application processor(s) 2206, cellular baseband processor(s) 2224, transceiver(s) 2222, antenna(s) 2280, and/or cross-slot channel estimation component 198 of FIG. 22. For example, referring to FIGS. 9-18, the UE 1804 may receive a second transmission 1810 and perform, at 1812, a channel estimation for the second transmission using the MT network 1760 including the modules illustrated in FIGS. 9-16.

As described in relation to FIG. 19, the UE may decode the second transmission based on the estimated second channel and may, at 2019, store the decoded second transmission and/or, at 2020, transmit, based on the decoded second transmission and for a source of the second transmission, a response to the second transmission. For example, referring to FIG. 18, the UE 1804 may decode the second transmission 1810 and transmit response 1819.

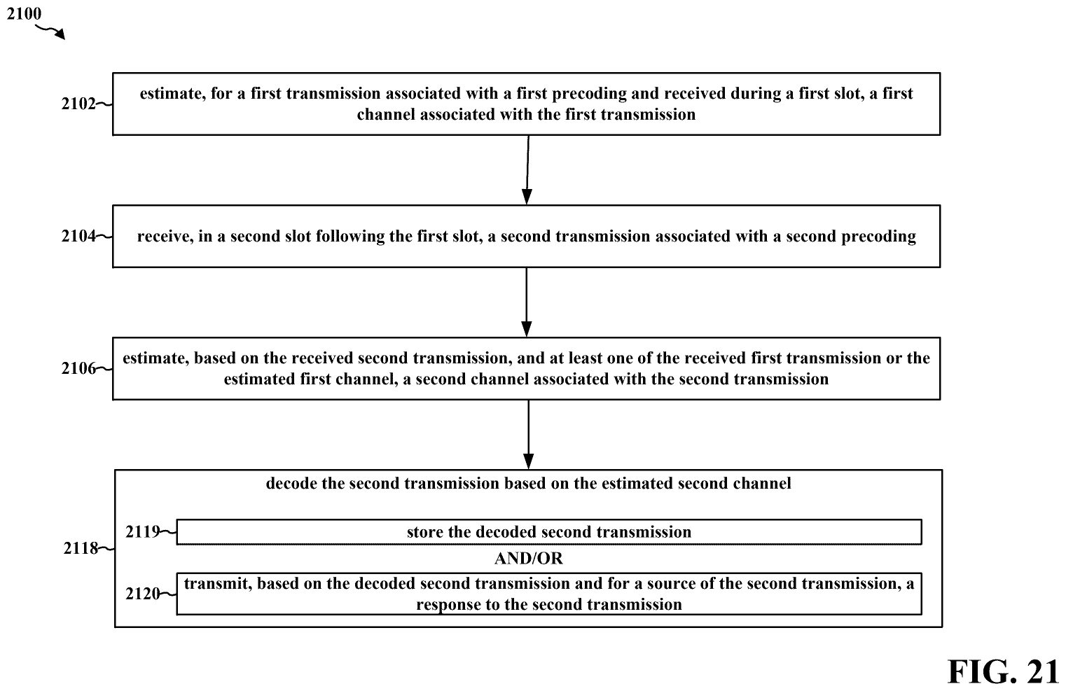

FIG. 21 is a flowchart 2100 of a method of wireless communication. The method may be performed by a UE (e.g., the UE 104, 404, 1804; the apparatus 2204). At 2102, the UE may estimate, for a first transmission in a first slot, a first channel associated with the first transmission. For example, 2102 may be performed by application processor(s) 2206, cellular baseband processor(s) 2224, transceiver(s) 2222, antenna(s) 2280, and/or cross-slot channel estimation component 198 of FIG. 22. In some aspects, the first transmission may be associated with a first precoding. The first transmission, in some aspects, may further be associated with a first DMRS pattern, a first number of PRBs in at least a first PRG associated with the first precoding, a first SCS, and a first number of layers. In some aspects, the estimation of the first channel may be performed using a neural network. The neural network, in some aspects, may include at least a CNN and one of a refinement network or RNN. For example, referring to FIGS. 17 and 18, the UE 1804 may receive a first transmission 1806 and perform, at 1808, a channel estimate using the MT network 1710.

At 2104, the UE may receive, in a second slot following the first slot, a second transmission associated with a second precoding. For example, 2104 may be performed by application processor(s) 2206, cellular baseband processor(s) 2224, transceiver(s) 2222, antenna(s) 2280, and/or cross-slot channel estimation component 198 of FIG. 22. In some aspects, the second precoding associated with the second transmission may be different from the first precoding associated with the first transmission. The second transmission, in some aspects, may further be associated with a second DMRS pattern, a second number of PRBs in at least a second PRG associated with the second precoding, a second SCS, and a second number of layers. In some aspects, at least one of (1) the second DMRS pattern may be different from the first DMRS pattern, (2) the second number of PRBs may be different from the first number of PRBs, (3) the second SCS may be different from the first SCS, or (4) the second number of layers may be different from the first number of layers. For example, referring to FIG. 18, the UE 1804 may receive the second transmission 1810.

At 2106, the UE may estimate, based on the received second transmission and at least one of the received first transmission or the estimated first channel, a second channel associated with the second transmission. For example, 2106 may be performed by application processor(s) 2206, cellular baseband processor(s) 2224, transceiver(s) 2222, antenna(s) 2280, and/or cross-slot channel estimation component 198 of FIG. 22. In some aspects, the estimation of the second channel may not be based on an explicit indication that the second precoding is different from the first precoding. In some aspects, the estimation of the second channel may be performed using a neural network. The neural network, in some aspects, may include at least a CNN and one of a refinement network or RNN. An input to the neural network for the estimation of the second channel, in some aspects, may include at least (1) a first estimation of the second channel based on a MMSE based on a DMRS pattern associated with the second transmission, and (2) information based on the first channel estimation performed using the neural network, wherein the information comprises the estimated first channel and state information based on at least the first channel estimation. In some aspects, the state information may further be based on a set of additional channel estimations performed using the neural network, where the set of additional channel estimations may be associated with a corresponding set of slots preceding the first slot. The input to the neural network for the estimation of the second channel, in some aspects, may further include (1) an indication of the DMRS pattern, (2) a set of DMRS tones associated with the DMRS patterns, and (3) a set of SNRs (or SNR information) associated with the second transmission. For example, referring to FIGS. 17 and 18, the UE 1804 may receive a second transmission 1810 and perform, at 1812, a channel estimation for the second transmission using the MT network 1760.

In some aspects, the estimation of the second channel using the neural network may include generating, using the CNN, a plurality of SISO channel estimates. The second transmission, in some aspects, may be associated with a set of layers, where each layer of the set of layers may be associated with a set of PRGs and where each PRG may include a plurality of PRBs. Accordingly, in some aspects, the plurality of SISO channel estimates may include a SISO channel estimate for each PRB in each layer of the set of layers. In some aspects, the state information includes a plurality of sets of SISO state information corresponding to the plurality of SISO channel estimates. The plurality of sets of SISO state information, in some aspects, includes a set of SISO state information for each PRB in each layer of the set of layers. In some aspects, the estimation of the second channel using the neural network at 2106 includes an iterative process (at the RNN) performed until a stopping condition is met. The iterative process, in some aspects, may include generating, based on a known DMRS pattern, a known transmitted DMRS symbol, and an observed and/or received DMRS signal and/or symbol, gradient information. The gradient information, in some aspects, may include a plurality of subsets of gradient information corresponding to the plurality of SISO channel estimates and the plurality of sets of SISO state information, where each subset of gradient information may be associated with a corresponding SISO channel estimate and a corresponding set of SISO state information (e.g., as described in relation to FIGS. 9 and 11). The iterative process, in some aspects, may further include updating the plurality of sets of SISO state information based on the gradient information and updating the plurality of sets of SISO state information based on sets of SISO state information for PRBs in a same PRG associated with a same layer in the plurality of sets of SISO state information.

The UE may determine if the set of PRGs includes a plurality of PRGs, and if so, the iterative process, in some aspects, may further include updating the plurality of sets of SISO state information based on sets of SISO state information for PRBs in the set of PRGs associated with a same layer in the plurality of sets of SISO state information. If the UE determines that the set of PRGs does not include a plurality of PRGs, the UE may determine if the set of layers includes a plurality of layers, and if so, the iterative process, in some aspects, may further include updating the plurality of sets of SISO state information based on sets of SISO state information for PRBs in the set of PRGs associated with a set of layers in the plurality of sets of SISO state information. After updating the plurality of sets of SISO state information based on sets of SISO state information for PRBs in the set of PRGs associated with a set of layers in the plurality of sets of SISO state information or determining that the set of layers does not include a plurality of layers, the iterative process, in some aspects, may further include updating the plurality of sets of SISO state information based on a second plurality of sets of SISO state information associated with the first transmission and updating the plurality of SISO channel estimates based on the gradient information and the updated plurality of sets of SISO state information. For example, referring to FIGS. 9-18, the UE 1804 may receive a second transmission 1810 and perform, at 1812, a channel estimation for the second transmission using the MT network 1760 including the modules illustrated in FIGS. 9-16.

At 2118, the UE may decode the second transmission based on the estimated second channel and may, at 2119, store the decoded second transmission and/or, at 2120, transmit, based on the decoded second transmission and for a source of the second transmission, a response to the second transmission. For example, 2118-2120 may be performed by application processor(s) 2206, cellular baseband processor(s) 2224, transceiver(s) 2222, antenna(s) 2280, and/or cross-slot channel estimation component 198 of FIG. 22. For example, referring to FIG. 18, the UE 1804 may decode the second transmission 1810 and transmit response 1819.

FIG. 22 is a diagram 2200 illustrating an example of a hardware implementation for an apparatus 2204. The apparatus 2204 may be a UE, a component of a UE, or may implement UE functionality. In some aspects, the apparatus_1004 may include at least one cellular baseband processor 2224 (also referred to as a modem) coupled to one or more transceivers 2222 (e.g., cellular RF transceiver). The cellular baseband processor(s) 2224 may include at least one on-chip memory 2224′. In some aspects, the apparatus 2204 may further include one or more subscriber identity modules (SIM) cards 2220 and at least one application processor 2206 coupled to a secure digital (SD) card 2208 and a screen 2210. The application processor(s) 2206 may include on-chip memory 2206′. In some aspects, the apparatus 2204 may further include a Bluetooth module 2212, a WLAN module 2214, an SPS module 2216 (e.g., GNSS module), one or more sensor modules 2218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2226, a power supply 2230, and/or a camera 2232. The Bluetooth module 2212, the WLAN module 2214, and the SPS module 2216 may include an on-chip transceiver (TRX) (or in some cases, just a receiver (RX)). The Bluetooth module 2212, the WLAN module 2214, and the SPS module 2216 may include their own dedicated antennas and/or utilize one or more antennas 2280 for communication. The cellular baseband processor(s) 2224 communicates through the transceiver(s) 2222 via the one or more antennas 2280 with the UE 104 and/or with an RU associated with a network entity 2202. The cellular baseband processor(s) 2224 and the application processor(s) 2206 may each include a computer-readable medium/memory 2224′, 2206′, respectively.

The additional memory modules 2226 may also be considered a computer-readable medium/memory. Each computer-readable medium/memory 2224′, 2206′, 2226 may be non-transitory. The cellular baseband processor(s) 2224 and the application processor(s) 2206 are each responsible for general processing, including the execution of software stored on the computer-readable medium/memory. The software, when executed by the cellular baseband processor(s) 2224/application processor(s) 2206, causes the cellular baseband processor(s) 2224/application processor(s) 2206 to perform the various functions described supra. The computer-readable medium/memory may also be used for storing data that is manipulated by the cellular baseband processor(s) 2224/application processor(s) 2206 when executing software. The cellular baseband processor(s) 2224/application processor(s) 2206 may be a component of the UE 350 and may include the at least one memory 360 and/or at least one of the TX processor 368, the RX processor 356, and the controller/processor 359. In one configuration, the apparatus 2204 may be at least one processor chip (modem and/or application) and include just the cellular baseband processor(s) 2224 and/or the application processor(s) 2206, and in another configuration, the apparatus 2204 may be the entire UE (e.g., see UE 350 of FIG. 3) and include the additional modules of the apparatus 2204.

As discussed supra, the cross-slot channel estimation component 198 may be configured to estimate, for a first transmission in a first slot, a first channel associated with the first transmission, wherein the first transmission is associated with a first precoding, receive, in a second slot following the first slot, a second transmission associated with a second precoding, and estimate, based on the received second transmission and at least one of the received first transmission or the estimated first channel, a second channel associated with the second transmission. The cross-slot channel estimation component 198 may be within the cellular baseband processor(s) 2224, the application processor(s) 2206, or both the cellular baseband processor(s) 2224 and the application processor(s) 2206. The cross-slot channel estimation component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2204 may include a variety of components configured for various functions. In one configuration, the apparatus 2204, and in particular the cellular baseband processor(s) 2224 and/or the application processor(s) 2206, may include means for estimating, for a first transmission in a first slot, a first channel associated with the first transmission. The apparatus 2204, and in particular the cellular baseband processor(s) 2224 and/or the application processor(s) 2206, may include means for receiving, in a second slot following the first slot, a second transmission associated with a second precoding. The apparatus 2204, and in particular the cellular baseband processor(s) 2224 and/or the application processor(s) 2206, may include means for estimating, based on the received second transmission and at least one of the received first transmission or the estimated first channel, a second channel associated with the second transmission. The apparatus 2204, and in particular the cellular baseband processor(s) 2224 and/or the application processor(s) 2206, may include means for decoding the second transmission based on the estimated second channel. The apparatus 2204, and in particular the cellular baseband processor(s) 2224 and/or the application processor(s) 2206, may include means for storing the decoded second transmission. The apparatus 2204, and in particular the cellular baseband processor(s) 2224 and/or the application processor(s) 2206, may include means for transmitting, based on the decoded second transmission and for a source of the second transmission, a response to the second transmission. The apparatus 2204, and in particular the cellular baseband processor(s) 2224 and/or the application processor(s) 2206, may include means for generating, using the CNN, a plurality of SISO channel estimates. The apparatus 2204, and in particular the cellular baseband processor(s) 2224 and/or the application processor(s) 2206, may include means for iteratively, until a stopping condition is met: generating, based on a known DMRS pattern, a known transmitted DMRS tone, and a received DMRS tone, gradient information; updating the plurality of sets of SISO state information based on the gradient information; updating the plurality of sets of SISO state information based on sets of SISO state information for PRBs in a same PRG associated with a same layer in the plurality of sets of SISO state information; updating, if the set of PRGs comprises a plurality of PRGs, the plurality of sets of SISO state information based on sets of SISO state information for PRBs in the set of PRGs associated with a same layer in the plurality of sets of SISO state information; updating, if the set of layers comprises a plurality of layers, the plurality of sets of SISO state information based on sets of SISO state information for PRBs in the set of PRGs associated with a set of layers in the plurality of sets of SISO state information; updating the plurality of sets of SISO state information based on a second plurality of sets of SISO state information associated with the first transmission; and updating the plurality of SISO channel estimates based on the gradient information and the updated plurality of sets of SISO state information. The apparatus 2204, and in particular the cellular baseband processor(s) 2224 and/or the application processor(s) 2206, may include means for receiving, in a third slot following the second slot and adjacent to the second slot, a third transmission associated with a third precoding. The apparatus 2204, and in particular the cellular baseband processor(s) 2224 and/or the application processor(s) 2206, may include means for estimating, based on the received third transmission and the output plurality of SISO channel estimates and an output plurality of sets of SISO state information from the RNN, a third channel associated with the third transmission. The apparatus 2204 may further include means for performing any of the aspects described in connection with the flowcharts in FIGS. 19-21, and/or performed by the UE in the communication flow of FIG. 18. The means may be the cross-slot channel estimation component 198 of the apparatus 2204 configured to perform the functions recited by the means. As described supra, the apparatus 2204 may include the TX processor 368, the RX processor 356, and the controller/processor 359. As such, in one configuration, the means may be the TX processor 368, the RX processor 356, and/or the controller/processor 359 configured to perform the functions recited by the means.

In some aspects of wireless communication, e.g., a fast fading environment, obtaining accurate channel state information (CSI) may be important to maintain high data throughput. OFDM systems often deploy pilot-based channel estimation techniques for obtaining CSI with sufficient accuracy. In some aspects of wireless communication, e.g., 5G NR, these pilot symbols may be referred to as demodulation reference signals (DMRS). In every transmission slot, DMRS symbols may be inserted for effective channel estimation used for demodulation at non-DMRS locations in that slot. In some aspects of 5G NR a fixed set of possible DMRS patterns may be configured and/or allowed. Depending on the channel characteristics, the optimal DMRS pattern, i.e., the DMRS pattern with the best expected data throughput, may be used. Channel estimation, in some aspects, involves finding the unknown values of the channel response (e.g., at non-DMRS locations) using some known channel responses at pilot locations (e.g., DMRS locations).

Various aspects relate generally to taking advantage of the correlation across slots in the DMRS-based channel estimation problem. Some aspects more specifically relate to taking advantage of the correlation across slots in the DMRS-based channel estimation problem with low additional complexity by adding an estimated channel from a last slot as input, and adding a cross-slot attention component in the refinement network encoder. In some examples, a wireless device may be configured to estimate, for a first transmission in a first slot, a first channel associated with the first transmission, wherein the first transmission is associated with a first precoding, receive, in a second slot following the first slot, a second transmission associated with a second precoding, and estimate, based on the received second transmission and at least one of the received first transmission or the estimated first channel, a second channel associated with the second transmission.

Particular aspects of the subject matter described in this disclosure can be implemented to realize one or more of the following potential advantages. In some examples, by adding an estimated channel from a last slot as input, and adding a cross-slot attention component in the refinement network encoder, the described techniques can be used to improve channel estimation accuracy over adaptive minimum mean square error (AMMSE) or MMSE with varying per-slot precoder, DMRS patterns, number of resource blocks associated with a channel estimation unit, and/or number of layers.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, comprising: estimating, for a first transmission in a first slot, a first channel associated with the first transmission, wherein the first transmission is associated with a first precoding; receiving, in a second slot following the first slot, a second transmission associated with a second precoding; and estimating, based on the received second transmission and at least one of the received first transmission or the estimated first channel, a second channel associated with the second transmission.

Aspect 2 is the method of aspect 1, further comprising decoding the second transmission based on the estimated second channel and at least one of: storing the decoded second transmission; or transmitting, based on the decoded second transmission and for a source of the second transmission, a response to the second transmission.

Aspect 3 is the method of any of aspects 1 and 2, wherein the second precoding associated with the second transmission is different from the first precoding associated with the first transmission.

Aspect 4 is the method of aspect of 3, wherein the estimation of the second channel is not based on an explicit indication that the second precoding is different from the first precoding.

Aspect 5 is the method of any of aspects 3 and 4, wherein: the first transmission is further associated with a first demodulation reference signal (DMRS) pattern, a first number of physical resource blocks (PRBs) in at least a first PRB group (PRG) associated with the first precoding, a first subcarrier spacing (SCS), and a first number of layers, the second transmission is further associated with a second DMRS pattern, a second number of PRBs in at least a second PRG associated with the second precoding, a second SCS, and a second number of layers, and at least one of (1) the second DMRS pattern is different from the first DMRS pattern, (2) the second number of PRBs is different from the first number of PRBs, (3) the second SCS is different from the first SCS, or (4) the second number of layers is different from the first number of layers.

Aspect 6 is the method of any of aspects 1 to 5, wherein each of the estimation of the first channel and the estimation of the second channel is performed using a neural network comprising at least a convolutional neural network (CNN) and a refinement neural network (RNN).

Aspect 7 is the method of aspect 6, wherein an input to the neural network for the estimation of the second channel comprises at least (1) a first estimation of the second channel based on a minimum mean square error (MMSE) based on a demodulation reference signal (DMRS) pattern associated with the second transmission, and (2) information based on the first channel estimation performed using the neural network, wherein the information comprises the estimated first channel and state information based on at least the first channel estimation.

Aspect 8 is the method of aspect 7, wherein the state information is further based on a set of additional channel estimations performed using the neural network, wherein the set of additional channel estimations is associated with a corresponding set of slots preceding the first slot.

Aspect 9 is the method of any of aspects 7 and 8, wherein the input to the neural network for the estimation of the second channel further comprises (1) an indication of the DMRS pattern, (2) a set of DMRS tones associated with the DMRS patterns, and (3) a set of signal to noise ratios (SNRs) associated with the second transmission.

Aspect 10 is the method of any of aspects 7 to 9, wherein the estimation of the second channel using the neural network comprises generating, using the CNN, a plurality of single input single output (SISO) channel estimates, wherein the second transmission is associated with a set of layers, wherein each layer of the set of layers is associated with a set of physical resource block groups (PRGs), wherein each PRG comprises a plurality of physical resource blocks (PRBs), and wherein the plurality of SISO channel estimates comprises a SISO channel estimate for each PRB in each layer of the set of layers.

Aspect 11 is the method of aspect 10, wherein the state information comprises a plurality of sets of SISO state information corresponding to the plurality of SISO channel estimates, wherein the plurality of sets of SISO state information comprises a set of SISO state information for each PRB in each layer of the set of layers, and the estimation of the second channel using the neural network comprises, iteratively, until a stopping condition is met: generating, based on a known DMRS pattern, a known transmitted DMRS symbol, and an observed DMRS signal and/or symbol, gradient information, wherein the gradient information comprises a plurality of subsets of gradient information corresponding to the plurality of SISO channel estimates and the plurality of sets of SISO state information, wherein each subset of gradient information is associated with a corresponding SISO channel estimate and a corresponding set of SISO state information; updating the plurality of sets of SISO state information based on the gradient information; updating the plurality of sets of SISO state information based on sets of SISO state information for PRBs in a same PRG associated with a same layer in the plurality of sets of SISO state information; updating, if the set of PRGs comprises a plurality of PRGs, the plurality of sets of SISO state information based on sets of SISO state information for PRBs in the set of PRGs associated with a same layer in the plurality of sets of SISO state information; updating, if the set of layers comprises a plurality of layers, the plurality of sets of SISO state information based on sets of SISO state information for PRBs in the set of PRGs associated with a set of layers in the plurality of sets of SISO state information; updating the plurality of sets of SISO state information based on a second plurality of sets of SISO state information associated with the first transmission; and updating the plurality of SISO channel estimates based on the gradient information and the updated plurality of sets of SISO state information.

Aspect 12 is the method of aspect 11, wherein updating the plurality of sets of SISO state information based on the second plurality of sets of SISO state information associated with the first transmission comprises updating each set of SISO state information in the plurality of sets of SISO state information based on a subset of the second plurality of sets of SISO state information associated with a same PRB and a same PRG as the set of SISO state information in the plurality of sets of SISO state information, wherein the subset of the second plurality of sets of SISO state information is associated with a second set of layers associated with the first transmission.

Aspect 13 is the method of any of aspects 11 and 12, wherein the stopping condition comprises one of a fixed number of iterations having been completed or a convergence condition, and wherein the estimated second channel comprises an output plurality of SISO channel estimates from the RNN.

Aspect 14 is the method of aspect 13, further comprising: receiving, in a third slot following the second slot and adjacent to the second slot, a third transmission associated with a third precoding; and estimating, based on the received third transmission and the output plurality of SISO channel estimates and an output plurality of sets of SISO state information from the RNN, a third channel associated with the third transmission.

Aspect 15 is the method of aspect 14, wherein the second precoding associated with the second transmission and the third precoding associated with the third transmission are a same precoding.

Aspect 16 is an apparatus for wireless communication at a device including a memory and at least one processor coupled to the memory and, based at least in part on information stored in the memory, the at least one processor is configured to implement any of aspects 1 to 15.

Aspect 17 is the apparatus of aspect 16, further including a transceiver or an antenna coupled to the at least one processor.

Aspect 18 is an apparatus for wireless communication at a device including means for implementing any of aspects 1 to 15.

Aspect 19 is a computer-readable medium (e.g., a non-transitory computer-readable medium) storing computer executable code, where the code when executed by a processor causes the processor to implement any of aspects 1 to 15.

What is claimed is:

1. An apparatus for wireless communication at a wireless device, comprising:
at least one memory; and
at least one processor coupled to the at least one memory and, based at least in part on stored information that is stored in the at least one memory, the at least one processor, individually or in any combination, is configured to:
estimate, for a first transmission in a first slot, a first channel associated with the first transmission, wherein the first transmission is associated with a first precoding;
receive, in a second slot following the first slot, a second transmission associated with a second precoding; and
estimate, based on the received second transmission and at least one of the received first transmission or the estimated first channel, a second channel associated with the second transmission.

2. The apparatus of claim 1, further comprising a transceiver coupled to the at least one processor, wherein the at least one processor, individually or in any combination, is further configured to decode the second transmission based on the estimated second channel and at least one of:
store the decoded second transmission; or
transmit, via the transceiver based on the decoded second transmission and for a source of the second transmission, a response to the second transmission.

3. The apparatus of claim 1, wherein the second precoding associated with the second transmission is different from the first precoding associated with the first transmission.

4. The apparatus of claim 3, wherein the estimation of the second channel is not based on an explicit indication that the second precoding is different from the first precoding.

5. The apparatus of claim 3, wherein:
the first transmission is further associated with a first demodulation reference signal (DMRS) pattern, a first number of physical resource blocks (PRBs) in at least a first PRB group (PRG) associated with the first precoding, a first subcarrier spacing (SCS), and a first number of layers,
the second transmission is further associated with a second DMRS pattern, a second number of PRBs in at least a second PRG associated with the second precoding, a second SCS, and a second number of layers, and
at least one of (1) the second DMRS pattern is different from the first DMRS pattern, (2) the second number of PRBs is different from the first number of PRBs, (3) the second SCS is different from the first SCS, or (4) the second number of layers is different from the first number of layers.

6. The apparatus of claim 1, wherein each of the estimation of the first channel and the estimation of the second channel is performed using a neural network comprising at least a convolutional neural network (CNN) and a refinement neural network (RNN).

7. The apparatus of claim 6, wherein an input to the neural network for the estimation of the second channel comprises at least (1) a first estimation of the second channel based on a minimum mean square error (MMSE) based on a demodulation reference signal (DMRS) pattern associated with the second transmission, and (2) information based on the first channel estimation performed using the neural network, wherein the information comprises the estimated first channel and state information based on at least the first channel estimation.

8. The apparatus of claim 7, wherein the state information is further based on a set of additional channel estimations performed using the neural network, wherein the set of additional channel estimations is associated with a corresponding set of slots preceding the first slot.

9. The apparatus of claim 7, wherein the input to the neural network for the estimation of the second channel further comprises (1) an indication of the DMRS pattern, (2) a set of DMRS tones associated with the DMRS patterns, and (3) a set of signal to noise ratios (SNRs) associated with the second transmission.

10. The apparatus of claim 7, wherein, to estimate the second channel using the neural network, the at least one processor, individually or in any combination, is further configured to generate, using the CNN, a plurality of single input single output (SISO) channel estimates, wherein the second transmission is associated with a set of layers, wherein each layer of the set of layers is associated with a set of physical resource block groups (PRGs), wherein each PRG comprises a plurality of physical resource blocks (PRBs), and wherein the plurality of SISO channel estimates comprises a SISO channel estimate for each PRB in each layer of the set of layers.

11. The apparatus of claim 10, wherein the state information comprises a plurality of sets of SISO state information corresponding to the plurality of SISO channel estimates, wherein the plurality of sets of SISO state information comprises a set of SISO state information for each PRB in each layer of the set of layers, and wherein, to estimate the second channel using the neural network, the at least one processor, individually or in any combination, is further configured to, iteratively, until a stopping condition is met:
generate, based on a known DMRS pattern, a known transmitted DMRS symbol, and an observed DMRS signal, gradient information, wherein the gradient information comprises a plurality of subsets of gradient information corresponding to the plurality of SISO channel estimates and the plurality of sets of SISO state information, wherein each subset of gradient information is associated with a corresponding SISO channel estimate and a corresponding set of SISO state information;
update the plurality of sets of SISO state information based on the gradient information;
update the plurality of sets of SISO state information based on sets of SISO state information for PRBs in a same PRG associated with a same layer in the plurality of sets of SISO state information;
update, if the set of PRGs comprises a plurality of PRGs, the plurality of sets of SISO state information based on sets of SISO state information for PRBs in the set of PRGs associated with a same layer in the plurality of sets of SISO state information;
update, if the set of layers comprises a plurality of layers, the plurality of sets of SISO state information based on sets of SISO state information for PRBs in the set of PRGs associated with a set of layers in the plurality of sets of SISO state information;
update the plurality of sets of SISO state information based on a second plurality of sets of SISO state information associated with the first transmission; and
update the plurality of SISO channel estimates based on the gradient information and the updated plurality of sets of SISO state information.

12. The apparatus of claim 11, wherein, to update the plurality of sets of SISO state information based on the second plurality of sets of SISO state information associated with the first transmission, the at least one processor, individually or in any combination, is further configured to update each set of SISO state information in the plurality of sets of SISO state information based on a subset of the second plurality of sets of SISO state information associated with a same PRB and a same PRG as the set of SISO state information in the plurality of sets of SISO state information, wherein the subset of the second plurality of sets of SISO state information is associated with a second set of layers associated with the first transmission.

13. The apparatus of claim 11, wherein the stopping condition comprises one of a fixed number of iterations having been completed or a convergence condition, and wherein the estimated second channel comprises an output plurality of SISO channel estimates from the RNN.

14. The apparatus of claim 13, wherein the at least one processor, individually or in any combination, is further configured to:
receive, in a third slot following the second slot and adjacent to the second slot, a third transmission associated with a third precoding; and
estimate, based on the received third transmission and the output plurality of SISO channel estimates and an output plurality of sets of SISO state information from the RNN, a third channel associated with the third transmission.

15. The apparatus of claim 14, wherein the second precoding associated with the second transmission and the third precoding associated with the third transmission are a same precoding.

16. A method of wireless communication at a wireless device, comprising:
estimating, for a first transmission in a first slot, a first channel associated with the first transmission, wherein the first transmission is associated with a first precoding;
receiving, in a second slot following the first slot, a second transmission associated with a second precoding; and
estimating, based on the received second transmission and at least one of the received first transmission or the estimated first channel, a second channel associated with the second transmission.

17. The method of claim 16, further comprising decoding the second transmission based on the estimated second channel and at least one of:
storing the decoded second transmission; or
transmitting, based on the decoded second transmission and for a source of the second transmission, a response to the second transmission.

18. The method of claim 16, wherein the second precoding associated with the second transmission is different from the first precoding associated with the first transmission.

19. The method of claim 18, wherein:
the first transmission is further associated with a first demodulation reference signal (DMRS) pattern, a first number of physical resource blocks (PRBs) in at least a first PRB group (PRG) associated with the first precoding, a first subcarrier spacing (SCS), and a first number of layers,
the second transmission is further associated with a second DMRS pattern, a second number of PRBs in at least a second PRG associated with the second precoding, a second SCS, and a second number of layers, and
at least one of (1) the second DMRS pattern is different from the first DMRS pattern, (2) the second number of PRBs is different from the first number of PRBs, (3) the second SCS is different from the first SCS, or (4) the second number of layers is different from the first number of layers.

20. A computer-readable medium storing computer executable code at a wireless device, the computer executable code when executed by at least one processor causes the at least one processor to:
estimate, for a first transmission in a first slot, a first channel associated with the first transmission, wherein the first transmission is associated with a first precoding;
receive, in a second slot following the first slot, a second transmission associated with a second precoding; and
estimate, based on the received second transmission and at least one of the received first transmission or the estimated first channel, a second channel associated with the second transmission.
